(19) United States
(12) Patent Application Publication
(10) Pub. No.: US 2018/0046671 A1
(43) Pub. Date: Feb. 15, 2018

(54) COMPUTER SCALE-OUT METHOD, COMPUTER SYSTEM, AND STORAGE MEDIUM

(71) Applicant: Hitachi, Ltd., Tokyo (JP)

(72) Inventors: Tsunehiko BABA, Tokyo (JP); Tsuneyuki IMAKI, Tokyo (JP)

(21) Appl. No.: 15/557,545

(22) PCT Filed: Oct. 30, 2015
(86) PCT No.: PCT/JP2015/080680

§ 371 Date: Sep. 12, 2017

(51) Int. Cl. G06F 17/30

(52) U.S. Cl. CPC G06F 17/30463; G06F 17/30516

(57) ABSTRACT

A computer scale-out method by adding a second computer to a first computer receiving stream data from a data source and executing a query to make the second computer execute the query, the computer scale-out method including: receiving, by a management computer, a request to scale out; a second step of generating, by the management computer, rewritten queries that are copies of the query; sending, by the management computer, instructions to scale out including the rewritten queries to the first computer and the second computer; receiving, by the first computer and the second computer, the instructions to scale out, extracting the rewritten queries, and switching to the extracted rewritten queries; notifying, by the first computer or the second computer, the management computer of readiness of the rewritten queries; and sending, by the management computer, an instruction to add the second computer as a destination to the data source.

### BACKGROUND

This invention relates to a computer system for stream data processing.

For stream data processing, high real-time processing capability is required that strictly ensures the order of processing with time-stamped tuples. To attain higher throughput for real-time data, the stream data processing needs to be improved in scalable performance.

U.S. Pat. No. 8,904,225 B is known as an example of scalable stream data processing. U.S. Pat. No. 8,904,225 B discloses a technique that dynamically adds a standby computer by copying the input stream and the internal state of a window query of an active computer to the standby computer from a specific time and guaranteeing that the standby computer is synchronized with the active computer based on the specific time.

U.S. Pat. No. 8,190,599 B discloses a technique that extracts a query that can be migrated at the smallest cost based on the amounts of data input to queries, window sizes, and/or CPU usages and dynamically migrates the extracted query to another server. U.S. Pat. No. 8,190,599 B provides a technique to scale out by migrating a part of a query graph to another server.

US 2013/0346390 A discloses a technique for a scalable load-balancing clustered streaming system that optimizes queries using a cost model and distributes the queries to the clustered system.

### SUMMARY

US 2013/0346390 A is a technique to optimize the static distribution of queries and has a problem that the optimized queries need to be modified or redistributed for dynamic scale-out.

U.S. Pat. No. 8,190,599 B is a technique to scale out by transferring a part of a query graph to another node to distribute the processing load to the other node and has a problem that a query causing high processing load cannot be executed in a plurality of nodes in parallel.

U.S. Pat. No. 8,904,225 B can perform dynamic scale-out by dynamically copying a query in an active computer to a standby computer and modifying the input stream for the active computer and the standby computer.

However, U.S. Pat. No. 8,904,225 B divides an input stream and distributes the divided input streams to the active computer and the standby computer. For this reason, if the queries in the active computer and the added standby computer are to process a serial input stream by window processing, like a query for counting or sorting, the result streams obtained by processing in the plurality of computers need to be aggregated in another node.

Accordingly, U.S. Pat. No. 8,904,225 B not only increases the load to divide and distribute an input stream but also adds the load of aggregation, causing a problem that shortage of the computer resources could occur.

This invention has been accomplished in view of the foregoing problems and an object of this invention is to dynamically distribute a query being executed by one computer to a plurality of computers to be executed.

A representative aspect of the present disclosure is as follows. A computer scale-out method by adding a second computer to a first computer receiving stream data from a data source and executing a query to make the second computer execute the query, the computer scale-out method comprising: a first step of receiving, by a management computer connected with the first computer and the second computer, a request to scale out; a second step of generating, by the management computer, rewritten queries that are copies of the query in which when to execute the query is rewritten; a third step of sending, by the management computer, instructions to scale out including the rewritten queries to the first computer and the second computer; a fourth step of receiving, by the first computer and the second computer, the instructions to scale out, extracting the rewritten queries, and switching to the extracted rewritten queries; a fifth step of notifying, by the first computer or the second computer, the management computer of readiness of the rewritten queries; and a sixth step of sending, by the management computer, an instruction to add the second computer as a destination of the stream data to the data source to make the data source send the same stream data to the first computer and the second computer.

This invention enables a query being executed by one computer to be dynamically distributed to a plurality of computers, while preventing shortage of computer resources and achieving leveling the loads to the computers.

### BRIEF DESCRIPTION OF THE DRAWINGS

FIG. 1 is a block diagram of an example of a computer system for stream data processing according to a first embodiment of this invention.

FIG. 2 is a block diagram for illustrating an example of the stream sending and receiving computer according to the first embodiment of this invention.

FIG. 3 is a block diagram for illustrating an example of the operation management computer according to the first embodiment of this invention.

FIG. 4 is a block diagram for illustrating an example of the first server computer according to the first embodiment of this invention.

FIG. 5 is a sequence diagram for illustrating an example of scale-out processing to be performed in a computer system according to the first embodiment of this invention.

FIG. 6 is a diagram for illustrating an example of the data destination management table according to the first embodiment of this invention.

FIG. 7 is a diagram for illustrating an example of the data destination management table according to the first embodiment of this invention.

FIG. 8 is a diagram for illustrating an example of the query management table according to the first embodiment of this invention.

FIG. 9 is a diagram for illustrating examples of query transformation templates according to the first embodiment of this invention.

FIG. 10 is a diagram for illustrating a relation of tuples processed in the first server computer and the second server computer to time according to the first embodiment of this invention.

FIG. 11 is a diagram for illustrating a relation of tuples processed in the first server computer and the second server computer to time according to the first embodiment of this invention.

FIG. 12 is a diagram for illustrating another example of a query transformation template according to the first embodiment of this invention.

FIG. 13 is a diagram for illustrating a relation of tuples processed in the first server computer and the second server computer to time according to the first embodiment of this invention.

FIG. 14 is a sequence diagram for illustrating another example of scale-out processing to be performed in a computer system according to the first embodiment of this invention.

FIG. 15 is a block diagram for illustrating an example of the first server computer according to a second embodiment of this invention.

FIG. 16 is a diagram for illustrating an example of the operation management computer according to the second embodiment of this invention.

FIG. 17 is a diagram for illustrating an example of the query status table according to the second embodiment of this invention.

FIG. 18 is a diagram for illustrating an example of the server status table according to the second embodiment of this invention.

FIG. 19 is a diagram for illustrating an example of the cluster status management table according to the second embodiment of this invention.

FIG. 20 is a flowchart of an example of scale-out processing according to the second embodiment of this invention.

FIG. 21 is a sequence diagram for illustrating an example of scale-out processing to be performed in a computer system according to the second embodiment of this invention.

FIG. 22 is a block diagram for illustrating an example of a server computer according to a third embodiment of this invention.

FIG. 23 is a sequence diagram for illustrating an example of scale-out processing to be performed in a computer system according to the third embodiment of this invention.

FIG. 24 is the former half of the sequence diagram for illustrating the scale-out processing performed in the computer system according to the third embodiment of this invention.

FIG. 25 is the latter half of the sequence diagram for illustrating the scale-out processing performed in the computer system according to the third embodiment of this invention.

### DETAILED DESCRIPTION OF THE EMBODIMENTS

Hereinafter, embodiments of this invention are described with reference to the accompanying drawings.

### Embodiment 1

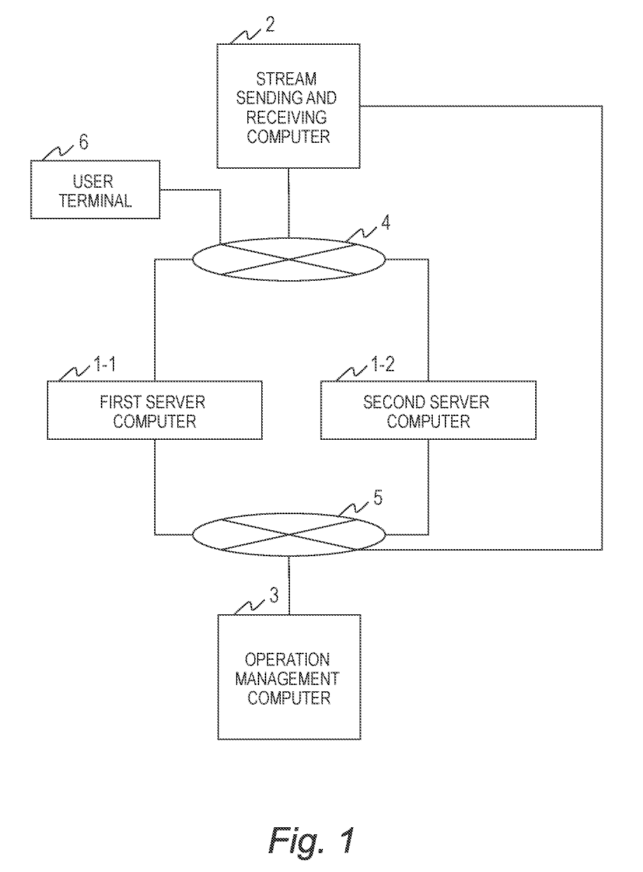

FIG. 1 is a block diagram of an example of a computer system for stream data processing, representing the first embodiment of this invention. The computer system includes a stream sending and receiving computer 2 for forwarding stream data, a first server computer 1-1 and a second server computer for processing the stream data, an operation management computer 3, and a user terminal 6 for using the result of the stream data processing.

The stream sending and receiving computer 2, the first server computer 1-1, the second server computer 1-2, and the user terminal 6 are connected by a business network and the stream sending and receiving computer 2 supplies stream data to the first server computer 1-1 and the second server computer 1-2. The calculation results of the first server computer 1-1 and the second server computer 1-2 are output to the user terminal 6 through the business network 4.

The first server computer 1-1 and the second server computer 1-2 are connected with the operation management computer 3 and the stream sending and receiving computer 2 by a management network 5. In this embodiment, the first server computer 1-1 and the second server computer 1-2 are generally referred to as server computers 1 by omitting the suffixes following “-”. This embodiment describes an example where two server computers 1 process stream data, but the number of server computers can be two or more.

The stream sending and receiving computer 2 is connected to a not-shown stream data source. The stream sending and receiving computer 2 functions as a stream data source for forwarding stream data to the server computers 1 through the business network 4. The steam data is data that arrives moment by moment like information acquired by various sensors or IC tags, or stock price information. This embodiment describes the stream sending and receiving computer 2 as a data source by way of example, but the data source can be a communication apparatus connected with a plurality of sensors or computers.

In this embodiment, stream data is assigned a stream ID as an identifier for identifying stream data. The stream ID is to identify the query with which the stream data is to be processed. The stream IDs are determined by the user in advance; for example, character strings such as S1, S2, and S3 are assigned as stream IDs.

### Stream Sending and Receiving Computer

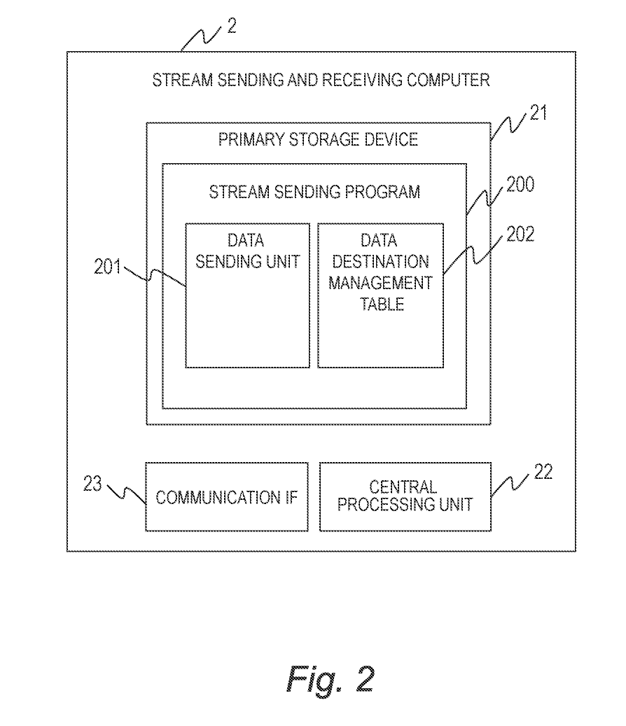

FIG. 2 is a block diagram for illustrating an example of the stream sending and receiving computer 2. The stream sending and receiving computer 2 includes a primary storage device 21, a central processing unit 22, and a communication interface 23.

The primary storage device 21 is a device for storing programs and data and can be a random access memory (RAM), for example. A stream sending program 200 is loaded to the primary storage device 21 and executed by the central processing unit 22.

The stream sending program 200 is a program for sending stream data input to the stream sending and receiving computer 2 to the destination (server computer(s) 1) and includes a data sending unit 201 and a data destination management table 202.

The central processing unit 22 includes a central processing unit (CPU), for example, and executes programs loaded to the primary storage device 21. In this embodiment, the central processing unit 22 executes the stream sending program 200 loaded to the primary storage device 21, as illustrated in FIG. 2.

The communication interface 23 is connected to the business network 4 and the management network 5. The communication interface 23 is performs data communication (information communication) between the stream data source and the first server computer 1-1 and between the stream data source and the second server computer 1-2 through the business network 4. The communication interface 23 is also used when the stream sending and receiving computer 2 performs data communication (information communication) with the operation management computer 3 through the management network 5. In the data communication with the first server computer 1-1 or the second server computer 1-2, stream data is sent from the stream sending and receiving computer 2 to the first server computer 1-1 or the second server computer 1-2.

In the data communication between the stream sending and receiving computer 2 and the operation management computer 3, predetermined commands are sent from the operation management computer 3 to the stream sending and receiving computer 2. Such commands include a command to change (add or remove) a destination (server computer).

This embodiment employs Ethernet as the communication interface 23, but instead of Ethernet, FDDI (an interface for optical fiber), a serial interface, or USB can also be used.

Next, the stream sending program 200 loaded to the primary storage device 21 of the stream sending and receiving computer 2 is described.

The data sending unit 201 of the stream sending program 200 sends stream data received by the stream sending and receiving computer 2 to the destination of the first server computer 1-1 or the second server computer 1-2 from the communication interface 23 through the business network 4.

The data sending unit 201 acquires the stream ID from the received stream data and acquires destination information associated with the stream ID from the data destination management table 202. The data sending unit 201 sends (forwards) the stream data to the server computer 1 identified by the extracted destination information.

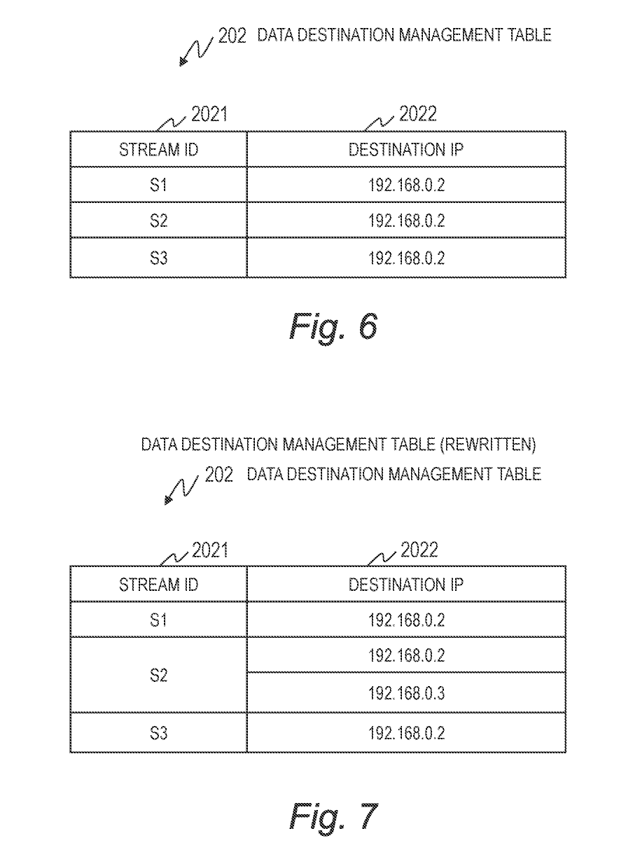

FIGS. 6 and 7 are diagrams for illustrating examples of the data destination management table 202. FIG. 7 is a diagram for illustrating an example of the data destination management table 202 rewritten in scale-out processing. The data destination management table 202 includes a stream ID 2021 storing the identifier of stream data and a destination IP 2022 storing the IP address of the destination (destination information) in an entry.

The data destination management table 202 in FIG. 7 is an example where a new destination has been added for the stream data of stream ID=S2 in accordance with a command from the operation management computer 3. After the data destination management table 202 is rewritten, the data sending unit 201 sends stream data of stream ID=S2 to the two server computers 1.

### Operation Management Computer

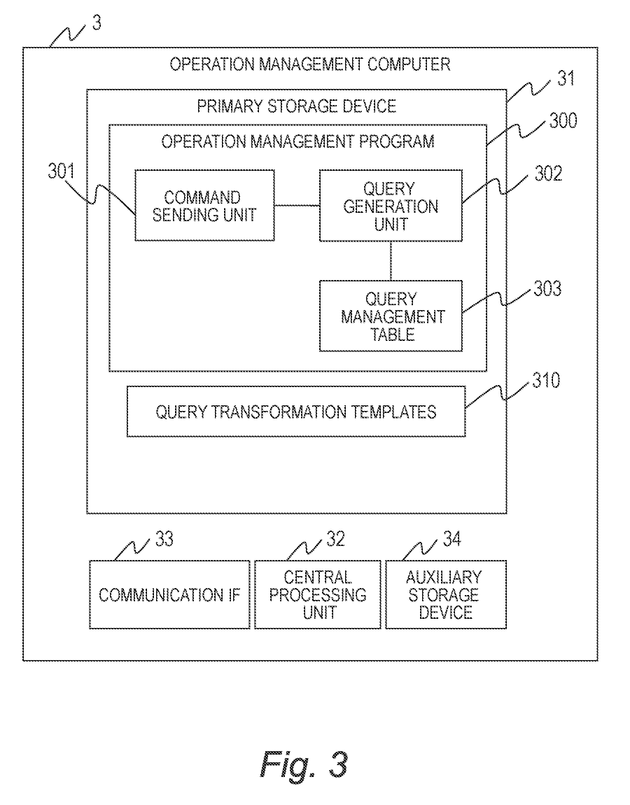

FIG. 3 is a block diagram for illustrating an example of the operation management computer 3. The operation management computer 3 includes a primary storage device 31, a central processing unit 32, a communication interface 33, and an auxiliary storage device 34. The primary storage device 31 is a device for storing programs and data, and can be a RAM, for example, like the primary storage device 21 of the above-described stream sending and receiving computer 2. An operation management program 300 and query transformation templates 310 are loaded to the primary storage device 1.

The operation management program 300 executes scale-out by adding a server computer 1 for stream data processing. The scale-out in this embodiment makes a query being executed by a server computer in operation (in this embodiment, the first server computer 1-1 as an active computer) to be executed by a newly added server computer (in this embodiment, the second server computer 1-2 as a standby computer) together. The second server computer 1-2 is a server computer 1 configured as a standby computer beforehand.

Scale-out in this embodiment rewrites a query being executed by a server computer 1, sends a query rewritten so as to be executed in a different timing mode to a newly added server 1, and makes the plurality of server computers 1 process the same stream data in parallel to distribute the load to the computer. The execution timing of the rewritten queries is configured so that the first server computer 1-1 and the second server computer 1-2 alternately output results of stream data processing.

Embodiment 1 provides an example where the operation management computer 3 outputs an instruction to scale out to the server computers 1. The trigger to output such an instruction can be determined using a known or well-known technique: for example, in response to an instruction from the administrator or when a predetermined condition is satisfied at a not-shown monitoring unit. As an example of sending an instruction to scale out when a predetermined condition is satisfied, the operation management program 300 monitors the load to the server computer 1 executing a query to output a request to scale out when the load to the computer exceeds a predetermined threshold. In the case where the server computer 1 is executing a plurality of queries, the operation management program 300 may designate a query to be scaled out in the instruction to scale out.

The operation management program 300 includes a command sending unit 301, a query generation unit 302, and a query management table 303. The operation management program 300 instructs the server computers 1 about rewrite of a query in scaling out, based on a query transformation template 310.

The auxiliary storage device 34 is a non-volatile storage medium for storing programs and data such as the operation management program 300 and the query transformation templates 310.

The communication interface 33 is used when the operation management computer 3 performs data communication (information communication) with the first server computer 1-1 or the second server computer 1-2 through the business network 4. The communication interface 33 is also connected with the stream sending and receiving computer 2 and the server computers 1 through the management network 5 and sends an instruction to scale out or information on an added server computer 1.

The central processing unit 32 is the same as the central processing unit 22 of the stream sending and receiving computer 2; for example, the central processing unit 32 includes a CPU and executes programs loaded to the primary storage device 31. In this embodiment, the central processing unit 32 executes the operation management program 300 loaded to the primary storage device 31, as illustrated in FIG. 3.

The function units of the command sending unit 301 and the query generation unit 302 included in the operation management program 300 are loaded to the primary storage device 31 as programs.

The central processing unit 32 performs processing in accordance with the programs of the function units to work as the function units for providing predetermined functions. For example, the central processing 32 performs processing in accordance with the command generation program to function as the command sending unit 301. The same applies to the other programs. Furthermore, the central processing unit 32 works as function units for providing the functions of a plurality of processes executed by each program. Each computer and the computer system is an apparatus and a system including these function units.

The programs for implementing the functions of the operation management computer 3 and information such as tables can be stored in the auxiliary storage device 34, a storage device such as a non-volatile semiconductor memory, a hard disk drive, or a solid-state drive (SSD), or a computer-readable non-transitory data storage medium such as an IC card, an SD card, or a DVD.

The operation management program 300 manages the server computers 1. Upon receipt of a request to scale out, the operation management program 300 determines a computer to be added and a query to be scaled out and instructs the server computers 1 and the stream sending and receiving computer 2. The operation management program 300 manages the queries executed by individual server computers 1 with the query management table 303. Alternatively, the operation management program 300 may monitor the server computers 1 and generates a request to scale out when a predetermined condition is satisfied.

The command sending unit 301 of the operation management program 300 creates an instruction to scale out or an instruction to add a computer and sends the instruction to a server computer 1 or the stream sending and receiving computer 2. The instruction to scale out includes rewritten queries generated by the query generation unit 302.

The query generation unit 302 of the operation management program 300 retrieves rewritten queries for the query to be scaled out from the query transformation templates 310 and generates queries in an executable format. The rewritten queries are queries based on the policies to rewrite configured in advance in the query transformation templates 310 and to make a plurality of server computers 1 execute the same processing at different times.

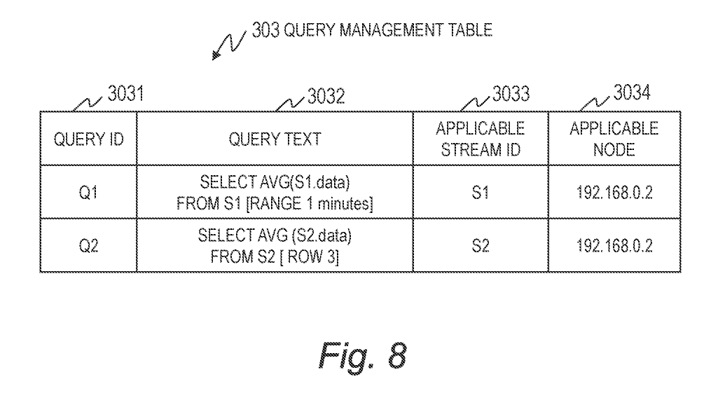

FIG. 8 is a diagram for illustrating an example of the query management table 303. The query management table 303 includes a query ID 3031 for storing the identifier of a query, a query text 3032 for storing the description of the query, an applicable stream ID 3033 for storing the identifier of the stream data to be processed with the query, and an applicable node 3034 for storing information on the server computer 1 to execute the query in one entry.

This embodiment provides an example where the information on a server computer 1 is an IP address; however, the information can be any information as far as the server computer 1 is identifiable with the information. The operation management program 300 updates the query management table 303 when a server computer 1 to execute a query is added, changed, or removed. FIG. 8 provides an example where the first server computer 1-1 (192.168.0.2) executes two queries Q1 and Q2.

The query management table 303 is used to determine the query to be used for stream data that the first server computer 1-1 has received from the stream sending and receiving computer 2, for example. Accordingly, the query management table 303 includes fields to record the identifier of a query, the query text of the query, the storage location of the executable of the query, and the stream ID of the stream data to apply the query. The identifier of a query means a character string to be used to identify a registered query; hereinbelow, the character string can be referred to as “query ID”. The applicable stream ID is used to acquire stream data to be processed with the query.

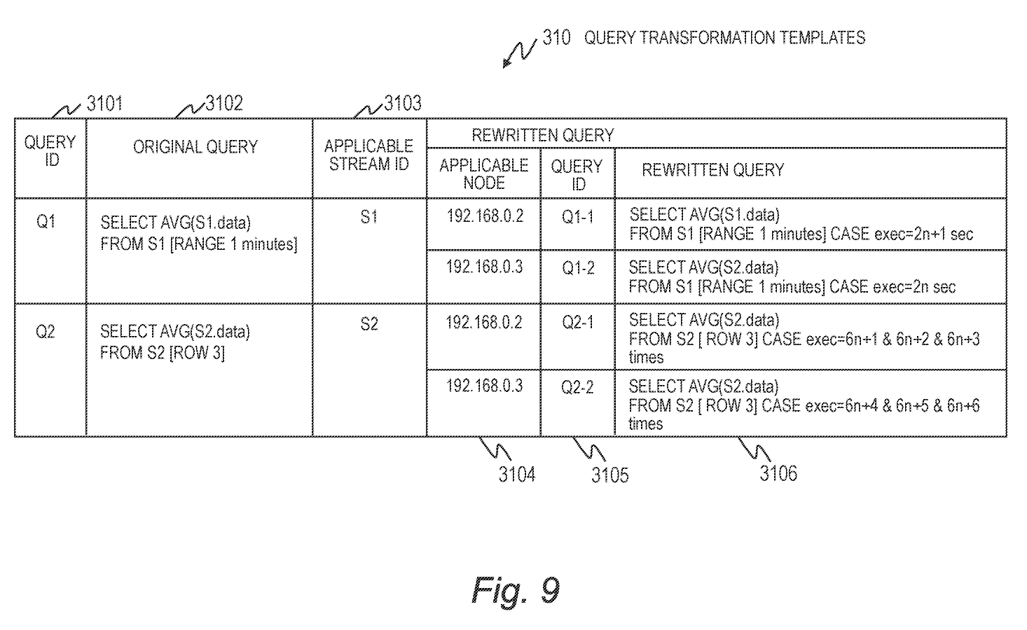

FIG. 9 is a diagram for illustrating examples of query transformation templates 310 that provide transformation rules to generate rewritten queries. The query template 310 includes a query ID 310 for storing the identifier of a query, an original query 3102 for storing the description of the query to be rewritten, an applicable stream ID 3102 for storing the identifier of stream data to be processed with the query, applicable nodes 3104 for storing information on the server computers 1 to execute the query, query IDs 3105 for storing the identifiers of the rewritten queries, and rewritten queries 3106 for storing the descriptions of the rewritten queries in one entry.

FIG. 9 provides an example for scaling out two queries Q1 and Q2 executed by the first server computer 1-1 by adding the server computer 1-2 (192.168.0.3). The query transformation templates 310 are configured by the administrator and stored in the operation management computer 3 in advance.

For example, in the case of a rewritten query identified by the query ID Q1-1, the rewritten query is described using a variable n representing the identification number of the computer between the server computers 1 to execute the query (n=1 for the server computer 1-1 and n=2 for the server computer 1-2). According to this template, the rewritten query is executed by the server computer 1-1 at every odd second (at every 2n+1 second).

This embodiment provides an example where the query transformation templates 310 are stored in the operation management computer 3, but the query transformation templates 310 may be stored in each of the server computers 1. The query transformation templates may employ a policy to describe a template for only a part of a query to be transformed or to combine one or more of such templates to apply.

### Server Computer

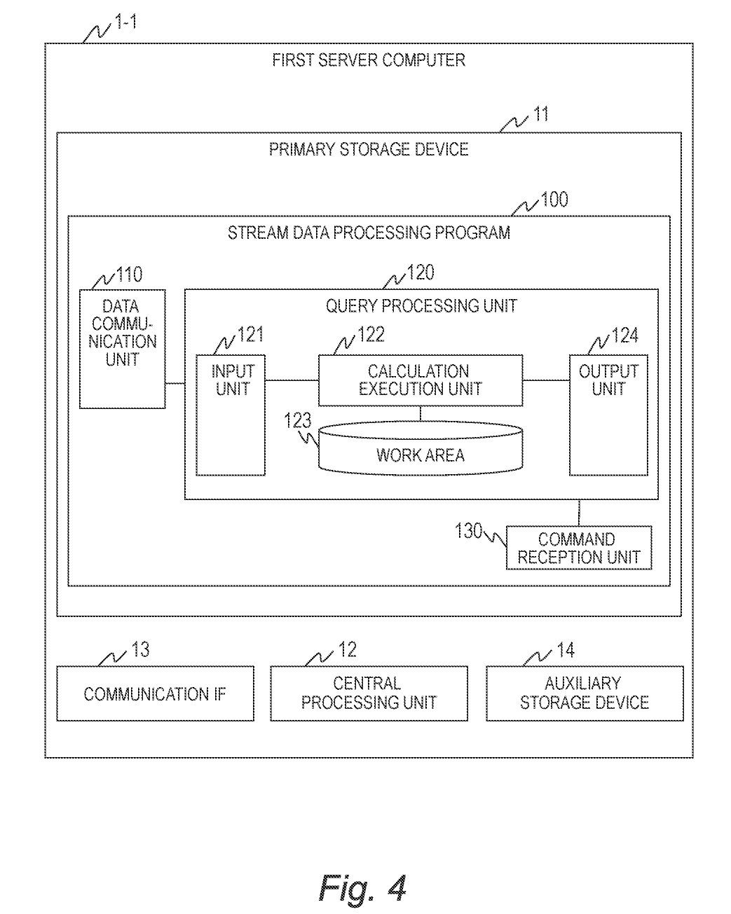

FIG. 4 is a block diagram for illustrating an example of the first server computer 1-1. The second server computer 1-2 has the same configuration as the first server computer 1-1 and therefore, duplicate explanations are omitted.

The server computer 1 includes a primary storage device 11, a central processing unit 12, a communication interface 13, and an auxiliary storage device 14. The primary storage device 11 is a device for storing programs and data and can be a RAM, for example, like the primary storage device 21 of the above-described stream sending and receiving computer 2. A stream data processing program 100 is loaded to the primary storage device 11.

The stream data processing program 100 switches queries and synchronizes the execution environment such as the window with the added server computer 1 in scaling out. The stream data processing program 100 includes a data communication unit 110, a query processing unit 120, and a command reception unit 130. To synchronize the execution environment, there are a cold standby method and a warm standby method, as will be described later.

The central processing unit 12 is the same as the central processing unit 22 of the stream sending and receiving computer 2; for example, the central processing unit 12 includes a CPU and executes programs loaded to the primary storage device 11. In this embodiment, the central processing unit 12 executes the stream data processing program 100 loaded to the primary storage device 11, as illustrated in FIG. 4.

The communication interface 13 is connected with the business network 4 and the management network 5 to receive stream data from the stream sending and receiving computer 2 and commands such as a command to scale out from the operation management computer 3.

The auxiliary storage device 14 includes a non-volatile storage medium for storing programs such as the stream data processing program 100 and data.

The central processing unit 12 performs processing in accordance with the programs of the function units to work as the function units for providing predetermined functions. For example, the central processing unit 12 performs processing in accordance with a query processing program in the stream data processing program 100 to function as a query processing unit 120. The same applies to the other programs. Furthermore, the central processing unit 12 works as function units for providing the functions of a plurality of processes executed by each program. Each computer and the computer system is an apparatus and a system including these function units.

The programs for implementing the functions of the server computer 1 and information such as tables can be stored in the auxiliary storage device 14, a storage device such as a non-volatile semiconductor memory, a hard disk drive, or an SSD, or a computer-readable non-transitory data storage medium such as an IC card, an SD card, or a DVD.

The stream data processing program 100 includes a data communication unit 110, a query processing unit 120, and a command reception unit 130.

The data communication unit 110 in the stream data processing program 100 has functions to receive stream data sent from the stream sending and receiving computer 2 to the first server computer 1-1 through the communication interface 13 and the business network 4 and output the received stream data to the query processing unit 120.

The query processing unit 120 includes an input unit 121, a calculation execution unit 122, a work area 123, and an output unit 124.

The query processing unit 120 processes stream data in accordance with a registered query. This embodiment describes an example where the first server computer 1-1 executes a query determined by the operation management computer 3 in advance.

In the query processing unit 120, the input unit 121 inputs stream data output from the data communication unit 110 and outputs the input stream data to the calculation execution unit 122. The work area 123 stores the stream data to be processed that has output from the calculation execution unit 122 and outputs the stored stream data to the calculation execution unit 122 in response to a data retrieval request from the calculation execution unit 122.

The calculation execution unit 122 retrieves stream data provided from the input unit 121 and processes the stream data with a predetermined query. The stream data processing in the calculation execution unit 122 executes a query on previously input stream data by using a sliding window, for example. For this purpose, the calculation execution unit 122 stores the stream data (tuples) to be processed by arithmetic operations to the work area 123.

The sliding window is a data storage unit for temporarily storing stream data to be processed by the arithmetic operations and is defined in the query. The stream data cut out by the sliding window is stored in the primary storage device 11 of the server computer 1-1 and used when the calculation execution unit 122 executes a query. For a language to describe a query including defining a sliding window, continuous query language (CQL) referred to in the aforementioned U.S. Pat. No. 8,190,599 B is a preferable example.

There are two types of queries: queries that specify the range of stream data to be processed with time and queries that specify the range of stream data to be processed with number of tuples (rows) of stream data. Hereinafter, the texts described in a query language are referred to as query texts; the queries that specify the range of stream data to be processed with time is referred to as time-based queries; and the queries that specify the range of stream data to be processed with number of tuples is referred to as element-based queries.

In the case where the query executed by the calculation execution unit 122 is a time-based query, the calculation execution unit 122 stores stream data input from the data communication unit 110 via the input unit 121 to the work area 123. The calculation execution unit 122 deletes the stream data stored in the work area 123 from the work area 123 when the storage period has expired.

In the case where the query is an element-based query, the calculation execution unit 122 also stores the input stream data to the work area 123. When the number of tuples stored in the work area 123 exceeds a predetermined number, the calculation execution unit 122 deletes tuples from the work area 123 in descending order of the storage period in the work area 123.

The output unit 124 outputs the result of execution of a query by the calculation execution unit 122 to the external through the data communication unit 110 and the communication interface 13.

Hereinafter, the work area 123 may be referred to as window, the data (stream data) held (stored) in the work area 123 as window data, and the storage period for the stream data or the number of tuples to be stored in the work area 123 as window size.

The command reception unit 130 receives commands from the operation management computer 3 or the cluster in scaling out. The commands to be given to the command reception unit 130 include a scale-out command, a query registration command, and a query deletion command. The query registration command is a command to register a query for making the first server computer 1-1 sequentially process data (stream data) input to the stream data processing program 100 to the query processing unit 120.

### Scale-Out Processing

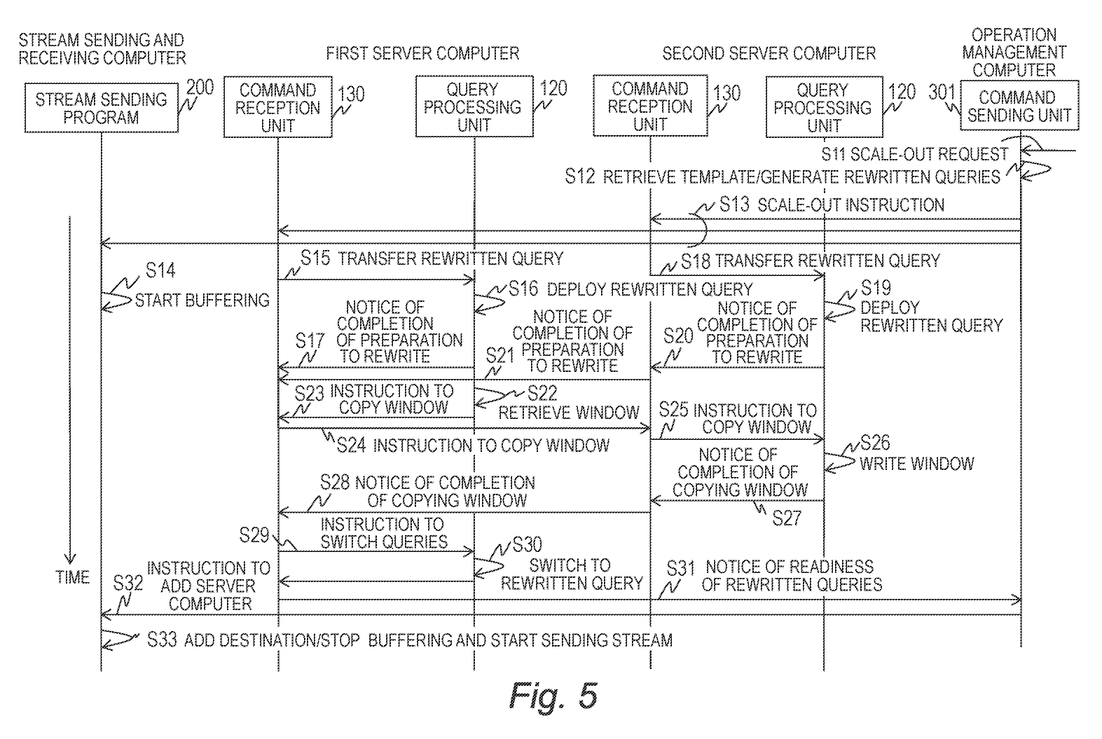

FIG. 5 is a sequence diagram for illustrating an example of scale-out processing to be performed in a computer system. This processing is executed when the operation management computer 3 receives a request to scale out. The operation management computer 3 outputs instructions to scale out to server computers 1 based on the scale-out request issued when a predetermined condition is satisfied or the operation management computer 3 receives an instruction to scale out from the administrator, as described above. FIG. 5 illustrates an example where the standby second server computer 1-2 is added to the cluster for executing a query for the first server computer 1-1.

The command sending unit 301 of the operation management program 300 in the operation management computer 3 receives a scale-out request in the form of satisfaction of a predetermined condition or an instruction from the administrator (S11). The operation management computer 3 acquires the query ID of the query to be scaled out and then acquires the applicable nodes 3104, the query IDs 3105, and the rewritten queries 3106 from the query transformation templates 310 shown in FIG. 5 (S12).

FIG. 5 provides an example of scaling out where the operation management computer 3 generates two rewritten queries of query IDs=Q1-1 and Q1-2 from the query of query ID=Q1 for the first server computer 1-1 (192.168.0.2) using the query transformation templates 310 and assigns the query of query ID=Q1-2 to the second server computer 1-2 (192.168.0.3).

In the example, the operation management computer 3 further generates two rewritten queries of query IDs=Q2-1 and Q2-2 from the query ID=Q2 for the first server computer 1-1 (192.168.0.2) and assigns the query of query ID=Q2-2 to the second server computer 1-2. In the example of FIG. 5, the operation management computer 3 renames the query ID=Q1 for the first server computer 1-1 to Q1-1 and renames the query ID=Q2 to Q2-1.

In Embodiment 1, the rewritten query Q1-1 for the first server computer 1-1 is a query to be switched from the query Q1 being executed by the first server computer 1-1 and the rewritten query Q1-2 for the second server computer 1-2 is a query to be newly started in the second server computer 1-2. The rewritten query Q2-1 for the first server computer 1-1 is also a query to be switched from the query Q2 being executed by the first server computer 1-1 and the rewritten query Q2-2 for the second server computer 1-2 is a query to be newly started in the second server computer 1-2.

The command sending unit 301 of the operation management program 300 includes the acquired rewritten queries 3106 into scale-out instructions and sends the scale-out instructions to the applicable nodes 3104 and the stream sending and receiving computer 2 (S13). In the example of FIG. 5, when to execute of a query for performing the same processing is rewritten for each applicable node 3104 and two server computers 1 process stream data in parallel.

Upon receipt of the scale-out instruction, the stream sending and receiving computer 2 starts buffering the stream data to be sent to the first server computer 1-1 and suspends sending the stream data to the first server computer 1-1 (S14).

The first server computer 1-1 receives the scale-out instruction from the operation management computer 3 at the command reception unit 130. The command reception unit 130 extracts the rewritten queries Q1-1 and Q2-1 included in the scale-out instruction and sends them to the query processing unit 120 (S15).

The query processing unit 120 of the first server computer 1-1 deploys the received rewritten queries Q1-1 and Q2-1 and prepares to rewrite the queries Q1 and Q2 being executed (S16). The query processing unit 120 notifies the command reception unit 130 of completion of the preparation for the rewrite (S17).

The second server computer 1-2 receives the scale-out instruction from the operation management computer 3 at the command reception unit 130. The command reception unit 130 extracts the rewritten queries Q1-2 and Q2-2 included in the scale-out instruction and sends them to the query processing unit 120 (S18).

The query processing unit 120 of the second server computer 1-2 deploys the received rewritten queries Q1-2 and Q2-2 (S19). The query processing unit 120 notifies the command reception unit 130 of completion of the preparation to rewrite queries (S20). The command reception unit 130 of the second server computer 1-2 notifies the command reception unit 130 of the first server computer 1-1 of completion of the preparation to rewrite queries (S21). Since the second server computer 1-2 is not executing a query, it is sufficient that the second server computer 1-2 merely deploy the rewritten queries 3106.

Next, in the first server computer 1-1, the query processing unit 120 retrieves data in the windows for the queries Q1 and Q2 (S22) and then sends an instruction to copy the data in the windows to the windows for the rewritten queries in the second server computer 1-2 to the command reception unit 130 (S23). At this time, the query processing unit 120 writes data in the windows for the queries Q1 and Q2 to the windows for the rewritten queries Q1-1 and Q2-1 to synchronize the data.

The first server computer 1-1 sends an instruction to copy the data in the windows for the queries Q1 and Q2 retrieved by the query processing unit 120 to the command reception unit 130 of the second server computer 1-2 (S24).

The command reception unit 130 of the second server computer 1-2 extracts the copy of the data in the windows for the queries Q1 and Q2 in the first server computer 1-1 from the instruction to copy the windows and sends an instruction to copy the windows to the query processing unit 120 (S25). The query processing unit 120 of the second server computer 1-2 writes the data (copy) in the windows for the queries Q1 and Q2 in the first server computer 1-1 extracted from the received instruction to copy the windows to the windows defined in the rewritten queries Q1-2 and Q2-2 for the second server computer 1-2 (S26). Through these operations, the windows for the rewritten queries in the first server computer 1-1 is synchronized with the windows for the rewritten queries in the second server computer 1-2.

The query processing unit 120 of the second server computer 1-2 notifies the command reception unit 130 of completion of copying the windows (S27). The command reception unit 130 of the second server computer 1-2 notifies the command reception unit 130 of the first server computer 1-1 of the completion of copying the windows (S28).

Through the foregoing processing, the queries (rewritten queries) that are different in when to execute but are the same in processing are set to the first server computer 1-1 and the second server computer 1-2 and the windows for the rewritten queries are synchronized between the first server computer 1-1 and the second server computer 1-2. The command reception unit 130 of the first server computer 1-1 outputs an instruction to switch from the queries being executed to the deployed rewritten queries to the query processing unit 120 (S29). The query processing unit 120 stops executing the queries and switches to the deployed rewritten queries (S30). The second server computer 1-2 should start executing the rewritten queries by this time.

Next, the command reception unit 130 of the first server computer 1-1 notifies the operation management computer 3 of completion of preparation to execute the rewritten queries (S31). The operation management computer 3 sends an instruction to add the address of the new computer added in the scale-out to the stream sending and receiving computer 2 (S32).

The stream sending and receiving computer 2 adds a destination of the stream data by adding the received address to the data destination management table 202 (S33). The operation management computer 3 may notify the stream sending and receiving computer 2 of a new destination of the stream data to be processed by the query to be scaled out. That is to say, in response to an instruction to add the second server computer 1-2 (192.168.0.3) for the stream data of stream ID=S2, the stream sending and receiving computer 2 adds a new entry to the destination IP 2022 in the data destination management table 202, as shown in FIG. 7.

Furthermore, the stream sending and receiving computer 2 stops buffering stream data and starts sending stream data to the second server computer 1-2 as well as the first server computer 1-1 (S33).

In the above-described processing, in response to an instruction to scale out from the operation management computer 3, the stream sending and receiving computer 2 suspends sending stream data by buffering the stream data. The first server computer 1-1 and the second server computer 1-2 deploy rewritten queries and synchronize the windows for the queries. As soon as the windows have been synchronized, the first server computer 1-1 switches from the queries being executed to the deployed rewritten queries. The first server computer 1-1 notifies the operation management computer 3 of readiness of the rewritten queries and the operation management computer 3 instructs the stream sending and receiving computer 2 to add a new computer (the second server computer 1-2) to the destination of the stream data. The stream sending and receiving computer 2 adds the new computer to the destination and thereafter, stops the buffering and resumes sending stream data.

The above-described processing illustrated in FIG. 5 is called a warm standby method. In the warm standby method, the operation management computer 3 generates rewritten queries and sends the rewritten queries to the server computers 1 involved in the scale-out. The stream sending and receiving computer 2 suspends sending stream data to the first server computer 1-1 based on the instruction from the operation management computer 3.

The first server computer 1-1 copies the windows and sends the copy to the second server computer 1-2 to be added to synchronize the data in the windows. After completion of the synchronization, the first server computer 1-1 switches the queries to be executed to the rewritten queries. The operation management computer 3 makes the stream sending and receiving computer 2 resume sending stream data to complete the dynamic scaling out by the warm standby method. This processing enables dynamic scaling out while using the same stream data.

The time to start buffering stream data in the stream sending and receiving computer 2 can be delayed until completion of preparation to rewrite the queries is confirmed by the first server computer 1-1 and the second server computer 1-2 (S21).

In the above-described warm standby method in FIG. 5, copying the windows is performed after discontinuing the processing (suspending stream data); however, how to copy the windows is not limited to this example. As far as the data in the windows is synchronized between the plurality of server computers 1 involved in the scale-out, copying may be performed without suspending sending stream data (by copying the windows at each update). The stream sending and receiving computer 2 discontinues sending stream data when a predetermined amount of data has been copied. This approach reduces the buffering time in the data stream sending and receiving computer 2 and thereby reduces the outage time of query processing in the server computers 1.

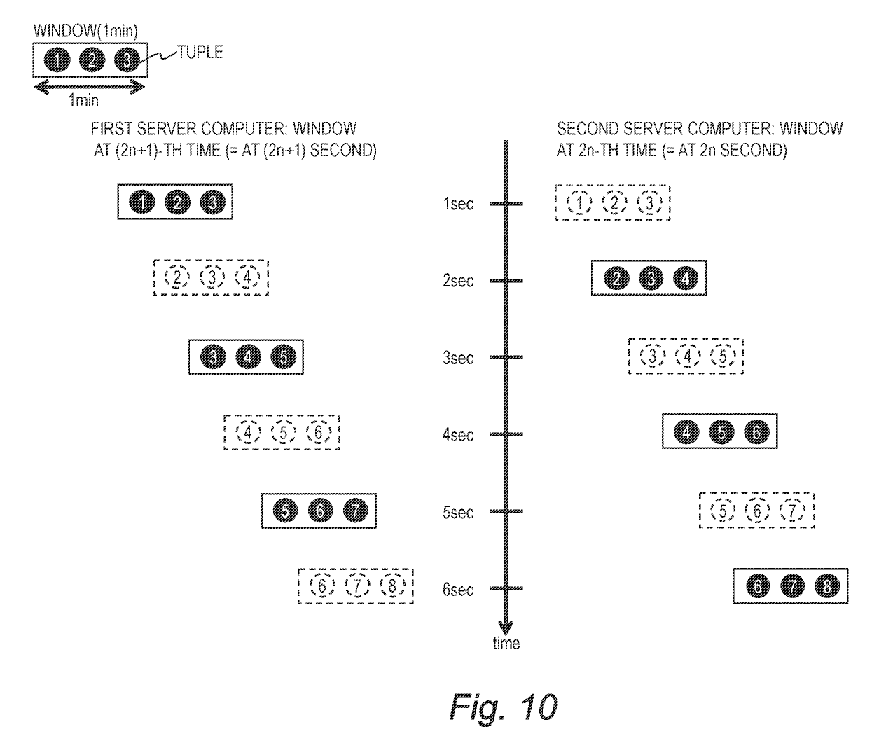

FIG. 10 is a diagram for illustrating a relation of tuples processed in the first server computer 1-1 and the second server computer 1-2 to time. The circles in the drawing represent tuples; the tuples surrounded by solid lines represent tuples on which results of stream data processing are output and the tuples surrounded by dashed lines represent tuples on which results of stream data processing are not output.

FIG. 10 illustrates an example of the queries of query IDs=Q1-1 and Q1-2 obtained by rewriting the query of query ID=Q1 in FIG. 9. The query of query ID=Q1 is to calculate the average in a window having a window size of one minute; the query of query ID=Q1-1 is to calculate the average in a window of one minute at each odd second and the query of query ID=Q1-2 is to calculate the average in a window of one minute at each even second.

That is to say, the first server computer 1-1 and the second server computer 1-2 perform stream data processing on the same input tuples and alternately output calculation results of the stream data processing at each second. Since the user terminal 6 to use the result of the stream data processing can use the calculation results of the first server computer 1-1 and the second server computer 1-2 in time series of tuples, aggregation like in the aforementioned existing art is not necessary.

The stream sending and receiving computer 2 for sending stream data as input tuples does not need to select or divide the tuples like in the aforementioned existing art, achieving low load for the distributed processing.

Although the identical tuples are input to the first and the second server computers 1-1 and 1-2, outputs from the queries to execute the same processing at different times are provided alternately; accordingly, the results of stream data processing are output alternately. This embodiment provides an example where queries are executed alternately but the way of executing the queries is not limited to this example. For example, the queries may be configured so that both of the first and the second server computers 1-1 and 1-2 perform calculation on the tuples 1, 2, and 3 and only the first server computer 1-1 outputs the processing result of the stream data at the time=1 sec. That is to say, calculation on the same tuples is performed by the plurality of server computers 1 and output of the result of the stream data processing is permitted in a specific order, such as alternately. In other words, the plurality of server computers 1 perform calculation on the same tuples but only the permitted server computer 1 outputs the result of the stream data processing and the other server computer 1 is prohibited from outputting (or skips outputting) the result of the stream data processing. Alternatively, the other server computer 1 may be prohibited from processing the stream data or skip processing the stream data.

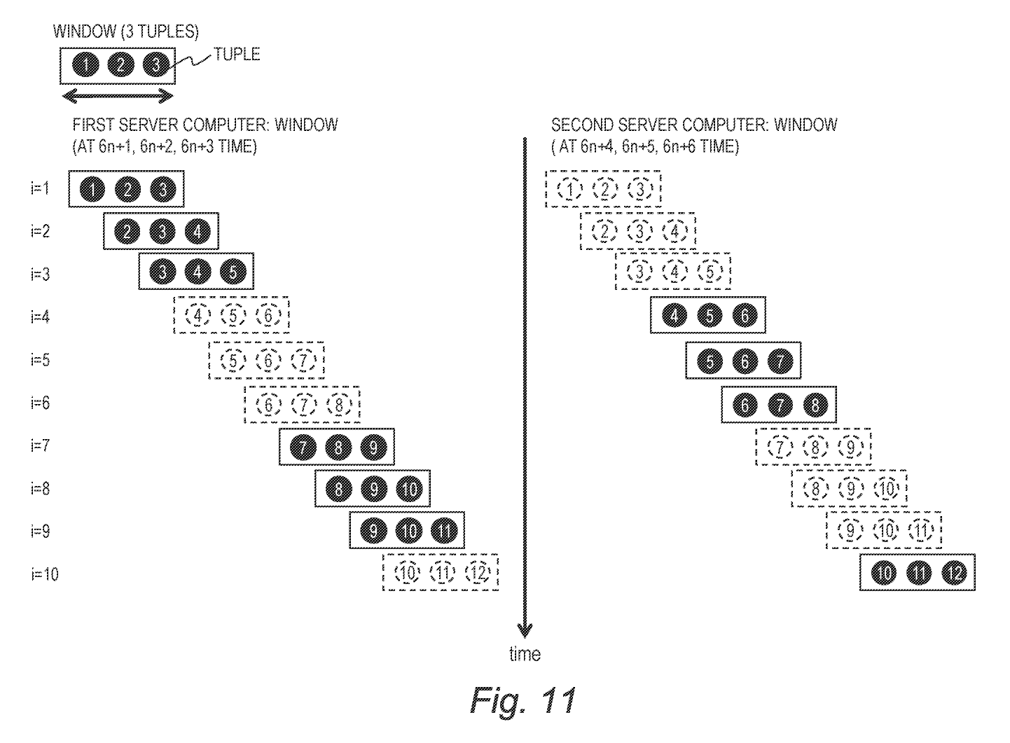

FIG. 11 is a diagram for illustrating a relation of tuples processed in the first server computer 1-1 and the second server computer 1-2 to time. The circles in the drawing represent tuples; the tuples surrounded by solid lines represent tuples on which results of stream data processing are output and the tuples surrounded by dashed lines represent tuples on which results of stream data processing are not output.

FIG. 11 illustrates an example of the queries of query IDs=Q2-1 and Q2-2 obtained by rewriting the query of query ID=Q2 in FIG. 9. The query of query ID =Q2 is to calculate the average in a window having a window size of three tuples; the queries of query IDs=Q2-1 and Q2-2 alternately execute calculation on the window three consecutive times.

The first server computer 1-1 and the second server computer 1-2 perform stream data processing on the same input tuples and alternately output three consecutive results of calculation on the window.

Since the user terminal 6 to use the result of the stream data processing can use the calculation results of the first server computer 1-1 and the second server computer 1-2 in time series of tuples, aggregation like in the aforementioned existing art is not necessary. Accordingly, the computer resources can be saved.

The stream sending and receiving computer 2 for sending stream data does not need to divide the stream data like in the aforementioned existing art; accordingly, the computer resources can be saved.

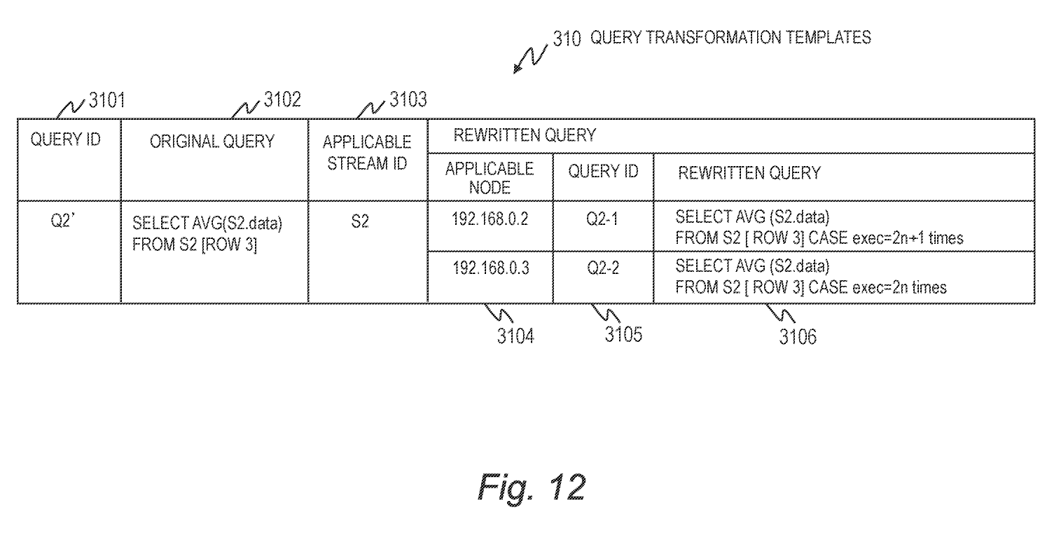

FIG. 12 is a diagram for illustrating another example of a query transformation template 310. The query template 310 in FIG. 12 provides modified examples of the queries of query IDs 3105=Q2-1 and Q2-2 obtained by rewriting the aforementioned query of query ID=Q2 in FIG. 9. FIG. 12 provides an example where the first server computer 1-1 and the second server computer 1-2 alternately perform calculation on the window.

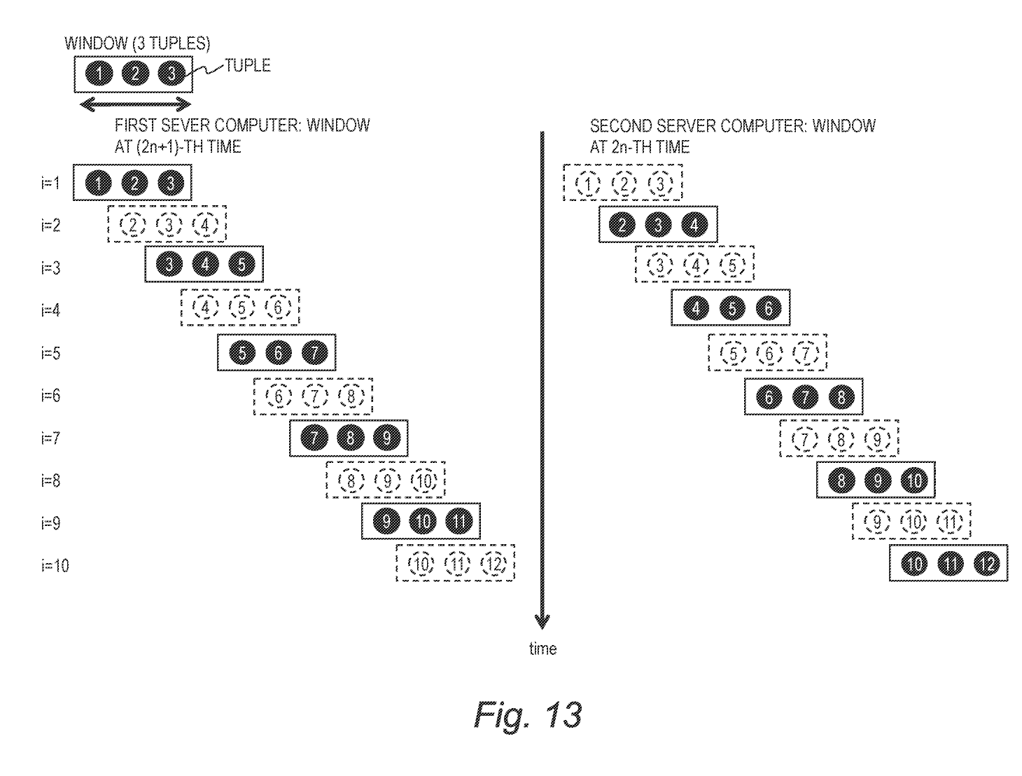

FIG. 13 is a diagram for illustrating a relation of tuples processed in the first server computer 1-1 and the second server computer 1-2 to time. The circles in the drawing represent tuples; the tuples surrounded by solid lines represent tuples on which results of stream data processing are output and the tuples surrounded by dashed lines represent tuples on which results of stream data processing are not output.

FIG. 13 illustrates an example of the queries of query IDs=Q2-1 and Q2-2 obtained by rewriting the query of query ID=Q2 in FIG. 12. The rewritten query of query ID=Q2-1 calculates the average in a window having a window size of three tuples at every odd-numbered processing; the queries of query ID=Q2-2 calculates the average in a window having a window size of three tuples at every even-numbered processing.

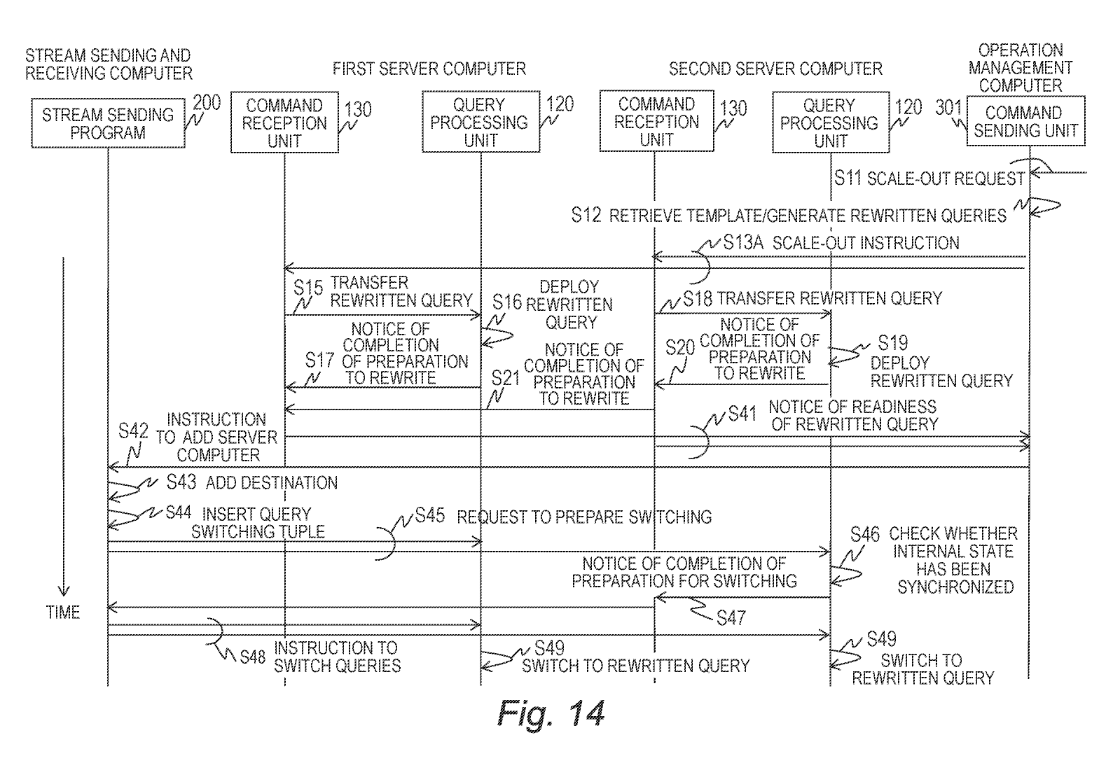

FIG. 14 is a sequence diagram for illustrating another example of scale-out processing to be performed in a computer system, representing a modified example of the above-described Embodiment 1.

Steps S11 and S12 are the same as those in the above-described FIG. 5, in which the operation management computer 3 that has received a scale-out request generates rewritten queries Q1-1, Q1-2, Q2-1, and Q2-2 using query transformation templates 310. At Step S 13A, the operation management computer 3 sends scale-out instructions including the rewritten queries to the server computers 1 involved in the scale-out.

Unlike in FIG. 5, the stream sending and receiving computer 2 in this modified example does not suspend sending stream data but keeps sending stream data to the first server computer 1-1.

At the subsequent steps S15 to S21, each of the first server computer 1-1 and the second server computer 1-2 involved in the scale-out sends the rewritten queries included in the scale-out instruction from the command reception unit 130 to the query processing unit 120 and deploys the rewritten queries in the server computer 1.

Unlike in FIG. 5, the stream sending and receiving computer 2 in this modified example does not suspend but keep sending stream data to the first server computer 1-1. Furthermore, unlike in FIG. 5, the command reception unit 130 of the first server computer 1-1 does not copy windows. Instead of copying windows, this modified example keeps sending stream data from the stream sending and receiving computer 2 and fills the windows for the rewritten queries Q1-1 to Q2-2 with data to synchronize the windows for the rewritten queries between the first server computer 1-1 and the second server computer 1-2.

At the subsequent step S41, the first server computer 1-1 and the second server computer 1-2 involved in the scale-out notify the operation management computer 3 of completion of deployment and readiness of the rewritten queries.

The operation management computer 3 sends an instruction to add the address of the new computer to be added to the stream sending and receiving computer 2 (S42). Like in FIG. 5, the stream sending and receiving computer 2 adds the received address to the data destination management table 202 to add a destination of stream data (S43).

Next, the stream sending and receiving computer 2 in this modified example inserts a query switching tuple to stream data to instruct the first server computer 1-1 and the second server computer 1-2 when to start the processing using the rewritten queries (S44). The query switching tuple is a tuple including predetermined data.

Next, the stream sending and receiving computer 2 sends switching instructions to switch the queries to be executed to the first server computer 1-1 and the second server computer 1-2 involved in the scale-out (S45). The query processing unit 120 of the newly added second server computer 1-2 determines whether the windows for the queries are filled with tuples to detect that the windows are synchronized between the first and the second server computers 1 (S46). Upon detection of synchronization, the second server computer 1-2 sends a notice of completion of preparation for switching to the stream sending and receiving computer 2 (S47).

Upon receipt of the notice of completion of preparation for switching, the stream sending and receiving computer 2 instructs the server computers 1 to switch the queries (S48).

The first server computer 1-1 and the second server computer 1-2 switches the processing to use the deployed rewritten queries (S49). Specifically, the first server computer 1-1 starts processing with the rewritten queries from the tuple next to the query switching tuple. The second server computer 1-2 stands by with the invoked rewritten queries until receiving the query switching tuple, and performs stream data processing with the rewritten queries on the tuples following the query switching tuple.

In this modified example, the stream sending and receiving computer 2 does not suspend sending stream data and the server computers 1 prepare the rewritten queries in advance. The server computers 1 involved in the scale-out synchronize the execution environment for the rewritten queries with each other by filling the windows for the rewritten queries with tuples and then switch the queries to be executed to complete dynamic scaling out.

The processing illustrated in FIG. 14 is called cold standby method. In the cold standby method, the operation management computer 3 generates rewritten queries and sends the rewritten queries to the server computers 1 involved in scale-out. The server computers 1 deploy the rewritten queries, input stream data to the windows for the rewritten queries, and fill the windows with stream data to achieve synchronization of the windows between the server computers 1 involved in the scale-out. Thereafter, the server computers 1 involved in the scale-out switch the queries to be executed to complete the dynamic scaling out by cold standby method.

In the above-described Embodiment 1, the operation management computer 3 sends a query for executing the same processing at different times to a new server computer 1 to achieve scale-out, which enables leveling the loads to the server computers 1 or leveling the network bandwidths for the server computers 1. Meanwhile, since the plurality of server computers 1 alternately execute queries, Embodiment 1 might not be able to improve the throughput of the stream data processing.

The above-described Embodiment 1 has provided an example of scaling out to two server computers 1; however, three or more server computers 3 may be involved in the scale-out. As the number of server computers 1 increases, the interval of execution (output) of the query or the number of times of execution (output) of the query to be skipped increases in one server computer 1.

The above-described Embodiment 1 has provided an example where rewritten queries are defined in a query transformation template 310; however, the operation management computer 3 may change the interval of execution of a rewritten query (or output of a result) for a server computer 1 depending on the number of server computers 1 to be added in the scale-out.

The above-described Embodiment 1 has provided an example where the operation management computer 3 is an independent computer in FIG. 1; however, the management computer 3 may be included either the first server computer 1-1 or the second server computer 1-2. The above-described Embodiment 1 has provided an example where the user terminal 6 uses the result of the stream data processing; however, the configuration is not limited to this. For example, the processing results of the first server computer 1-1 and the second server computer 1-2 may be processed by the next group of stream processing computers.

### Embodiment 2

The foregoing Embodiment 1 has provided an example of scaling out queries running on the first server computer 1-1 by adding the second server computer 1-2. Embodiment 2 provides an example of selectively scaling out a query. The trigger for scaling out is the same as the one in the foregoing Embodiment 1; for example, when a predetermined condition is satisfied in the operation management computer 3 or when the administrator of the operation management computer 3 issues an instruction to scale out. The server computers 1 to be involved in the scale out are the same as those in the foregoing Embodiment 1; a query in the first server computer 1-1 as an active computer is scaled out to the second server computer 1-2 as a standby computer.

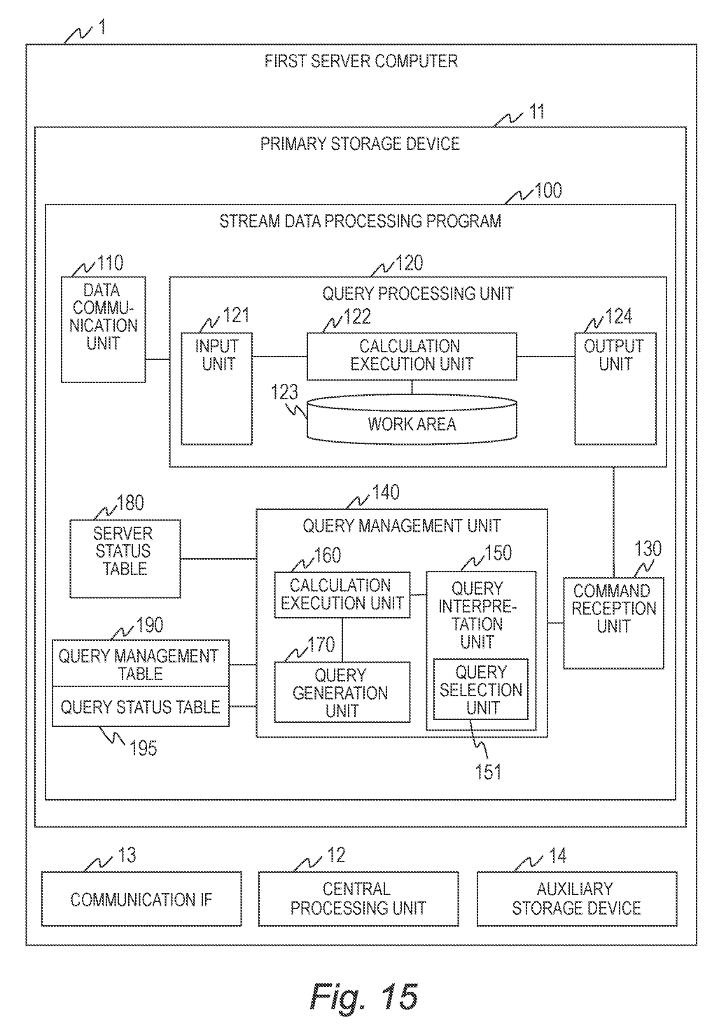

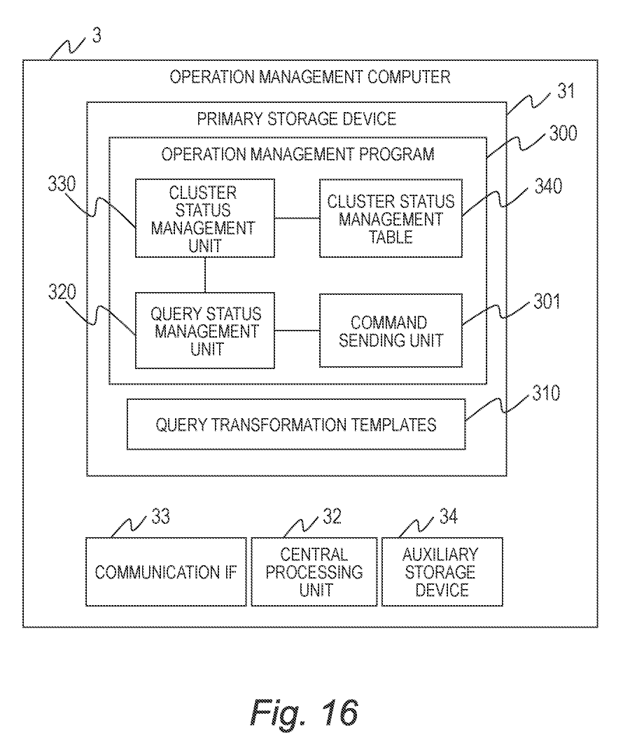

FIGS. 15 and 16 are block diagrams for illustrating examples of a server computer 1 and the operation management computer 3 in the second embodiment of this invention. As to the computer system, the first server computer 1-1 and the second server computer 1-2 in FIG. 1 are replaced by the server computers 1 in FIG. 15 and the operation management computer 3 in FIG. 1 is replaced by the operation management computer 3 in FIG. 16. The remaining configuration is the same as that of Embodiment 1.

FIG. 15 illustrates the first server computer 1-1 in Embodiment 2. Like in Embodiment 1, the second server computer 1-2 has the same configuration. The first server computer 1-1 includes a query management unit 140, a server status table 180, a query management table 190, and a query status table 195, in addition to the configuration in Embodiment 1 illustrated in FIG. 4. The remaining configuration is the same as that of Embodiment 1.

The query management unit 140 has a function to register or delete a query to be executed by the query processing unit 120 of the stream data processing program 100 and a function to generate an executable (for example, in a machine language or a machine-readable expression) from a query text (expressed by source code, for example, for the user to be able to understand the specifics of the query).

The technique for the query management unit 140 to generate an executable from a query text is not limited to a particular one; this application can employ a known or well-known technique.

In the query management unit 140, a query interpretation unit 150 has a function to interpret a query text. That is to say, the query interpretation unit 150 interprets a query text provided by the command reception unit 130 in registration of a query and provides the interpretation result to a calculation execution unit 160. The query interpretation unit 150 includes a query selection unit 151 for selecting a query to be scaled out. The query selection unit 151 selects a query based on the CPU usage, the network bandwidth usage, and the like in comparison to preset thresholds.

The calculation execution unit 160 receives the interpretation result of a query given by the query interpretation unit 150 and selects an efficient way to execute the query (or optimizes the query) based on the interpretation result. A query generation unit 170 generates an executable in the way selected by the calculation execution unit 160.

The query management unit 140 manages the server status table 180, the query management table 190, and the query status table 195.

The query management table 190 is the same as the query management table 190 in the operation management computer 3 illustrated in FIG. 8 in Embodiment 1. Embodiment 2 provides an example where the queries to be executed are managed by each server computer 1.

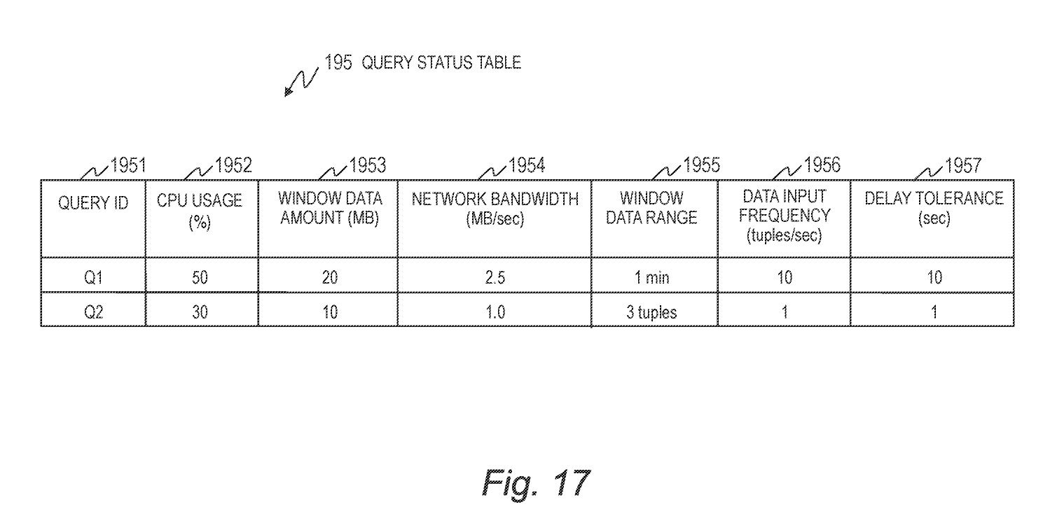

FIG. 17 is a diagram for illustrating an example of the query status table 195. The query status table 195 includes a query ID 1951 for storing the identifier of a query running in the server computer 1, a CPU usage 1952 for storing a CPU usage as resource usage for the query, a window data amount 1953 for storing the amount of data used in the window as resource usage for the query, a network bandwidth 1954 for storing a network bandwidth used for the query, a window data range 1955 for storing the window size for the query, a data input frequency 1956 for storing the frequency of data input (tuples/sec) representing the throughput of the query, and a delay tolerance 1957 for storing a tolerance for the delay time predetermined for the query in one entry.

The query management unit 140 monitors the operating conditions of each query at a predetermined cycle to update the query status table 195 with the monitoring result. The data input frequency in this example is the number of tuples of stream data input to the server computer 1 per unit time to be processed by the query and is a value representing the throughput of the query.

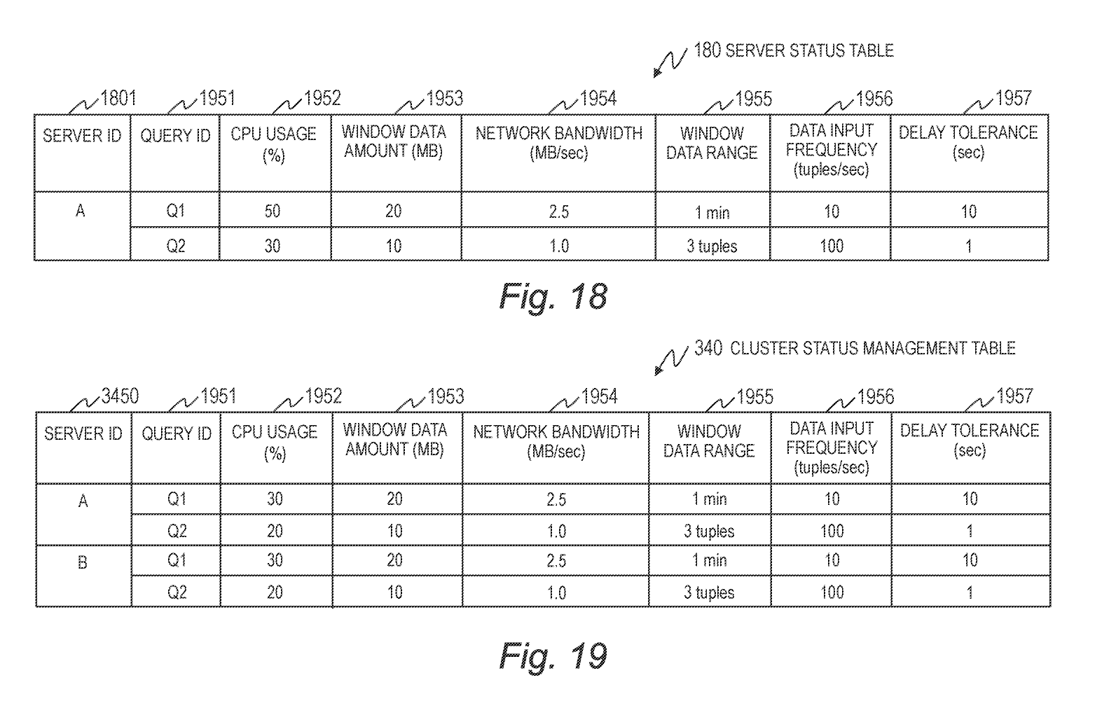

FIG. 18 is a diagram for illustrating an example of the server status table 180. The server status table 180 is a table obtained by adding a server ID 1801 for storing the identifier of the server 1 to the query status table 195 in FIG. 17. The server status table 180 is sent to the operation management computer 3 at a predetermined time.

FIG. 16 is a diagram for illustrating an example of the operation management computer 3 in Embodiment 2. The operation management computer 3 includes a query status management unit 320, a cluster status management unit 330, and a cluster status management table 340, in place of the query generation unit 302 and the query management table 303 in Embodiment 1 illustrated in FIG. 3. The remaining configuration is the same as that of Embodiment 1. The query status management unit 320 and the cluster status management unit 330 are executed by the central processing unit 32 as programs included in the operation management program 300.

In the operation management program 300, the cluster status management unit 330 collects information on the statuses of the queries on all server computers 1 (that is, the information in the server status tables 180 of the individual servers). The cluster status management unit 330 collects the information in the server status tables 180 managed by the query management units 140 of the server computers 1 (in the example in FIG. 1, the first server computer 1-1 and the second server computer 1-2) and creates the cluster status management table 340.

FIG. 19 is a diagram for illustrating an example of the cluster status management table 340. The cluster status management table 340 is a table obtained by joining the above-described server status tables 180 in FIG. 18 of the server computers 1 by server ID. In the cluster status management table 340, the identifiers of the server status tables 180 are set to server IDs 3450 and the remaining is the same as the query status table 195 in FIG. 17. The cluster status management table 340 in FIG. 19 is a state after scale-out.

The query status management unit 320 selects a query to be added to a newly added server computer (the second server computer 1-2 shown in FIG. 1) from all the queries to be executed by a server computer in operation (the first server computer 1-1 shown in FIG. 1) to perform scale-out.

Specifically, the query status management unit 320 calculates the individual costs (copying costs) to copy queries to another server computer 1, selects a query to be copied from the first server computer 1-1 to the second server computer 1-2 based on the copying costs, and makes the selected query to be executed. The query status management unit 320 calculates time (estimated) required to copy a query to be rewritten from the first server computer 1-1 in operation to the newly added second server computer 1-2 as a copying cost. The technique to calculate the copying cost is not described in detail here because it is the same as the migration cost disclosed in the aforementioned U.S. Pat. No. 8,190,599 B.

The scale-out processing in the computer system in this Embodiment 2 is performed as follows: the operation management computer 3 collects information on all queries, calculates copying costs using the collected information, and determines one or more queries that can be copied from the active first server computer 1-1 to the standby second server computer 1-2 within a short time and equalize the loads between the clustered server computers 1.

The operation management computer 3 copies the selected queries from the active first server computer 1-1 to the standby second server computer 1-2 and rewrites when to execute the queries. To prevent the processing from being delayed in copying the selected queries from the active first server computer 1-1 to the standby second server computer 1-2, copying the queries is performed by the cold standby method described in the above-described modified example of Embodiment 1, instead of the warm standby method described in the above-described Embodiment 1.

Next, a specific procedure of this scale-out processing is described.

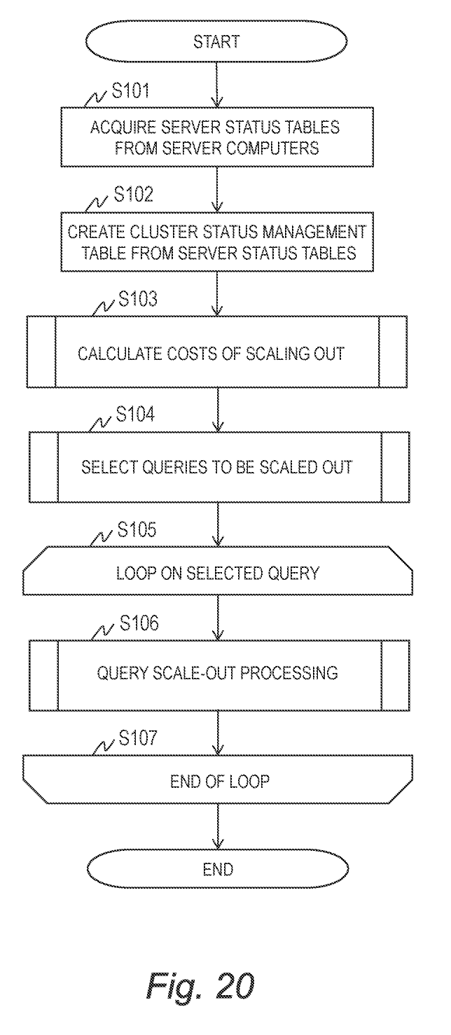

FIG. 20 is a flowchart of an example of scale-out processing. This processing is performed by the operation management computer 3 when scale-out is triggered.

In FIG. 20, the operation management computer 3 running the operation management program 300 acquires server status tables 180 from the server computers 1 (S101). Next, the operation management computer 3 creates a cluster status management table 340 by combining the acquired server status tables 180 (S102).

Next, the operation management computer 3 calculates individual copying costs to copy queries in the active first server computer 1-1 to the standby second server computer 1-2 in scaling out (S103).

The operation management computer 3 executes query selection processing. The details of the query selection processing are not described here because they are the same as those described in the aforementioned U.S. Pat. No. 8,190,599 B. Through the query selection processing, queries of query IDs of Q1 and Q2 are selected to be scaled out, for example (S104).

Upon completion of the query selection processing, the operation management computer 3 scales out each selected query by the loop processing of Steps S105 to S107.

Through the foregoing processing, scaling out is completed; the active first server computer 1-1 and the standby second server computer 1-2 alternately execute queries Q1 and Q2 to output the results of the stream data processing to the user terminal 6.

In the aforementioned query selection processing, selecting a query that requires the shortest copying time is repeated until the CPU usage of the standby second server computer 1-2 and a threshold preset as the target value of resource usage satisfy the following relation:

CPU usage≧Target value of resource usage.

In this embodiment, the operation management computer 3 starts the query selection processing with the target value for the resource usage of 50%, for example. The operation management computer 3 selects the query Q2 that requires the shortest copying time as a query to be scaled out. As a result, the total CPU usage of the first server computer 1-1 of the active server computer becomes 80% and the total CPU usage of the standby second server computer 1-2 becomes 20% (see FIGS. 18 and 19).

At this stage, the total CPU usage (20%) of the standby second server computer 1-2 is not higher than 50% as the target value of the resource usage; accordingly, the operation management computer 3 selects again the query that requires the shortest copying time (estimated) from the queries that have not been selected as a query to be scaled out. That is to say, the query Q1 that requires the shortest copying time next to the query Q2 is selected as a query to be scaled out. As a result of the foregoing processing, both of the total CPU usage of the first server computer 1-1 and the total CPU usage of the second server computer 1-2 become 50% (see FIG. 19).

Since the total CPU usage in the second server computer 1-2 has reached 50% of the target value of the resource usage, the operation management computer 3 terminates the processing to select the queries to be scaled out. As a result of the foregoing processing, the queries Q1 and Q2 are selected as the queries to be scaled out from the first server computer 1-1 to the second server computer 1-2.

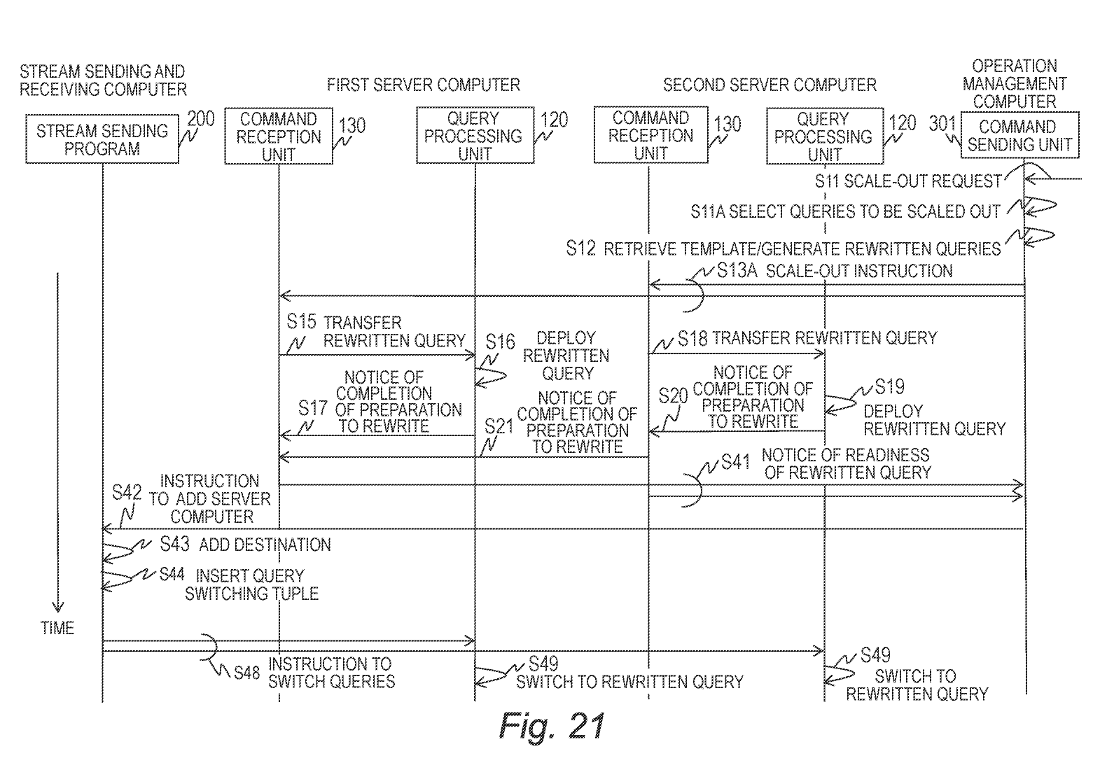

FIG. 21 is a sequence diagram for illustrating an example of scale-out processing to be performed in a computer system. The details of the scale-out processing performed in Steps S105 to 5207 are described as follows.

Step S11 is the same as Step S11 in FIG. 5 provided in Embodiment 1; the operation management computer 3 receives a scale-out request. At Step S11A, the operation management computer 3 selects queries to be scaled out through the above-described processing of Step S104 in FIG. 20.

Step S12 is the same as Step S12 in FIG. 5 provided in Embodiment 1; the operation management computer 3 generates rewritten queries with reference to the query transformation templates 310. The operation management computer 3 sends scale-out instructions including the rewritten queries to the first server computer 1-1 and the second server computer 1-2 involved in the scale-out (S13A).

The subsequent processing in this Embodiment 2 is the same as the processing of the above-described modified example in FIG. 14; the stream sending and receiving computer 2 keeps sending stream data to the first server computer 1-1 without suspension of sending stream data.

In Embodiment 2, the operation management computer 3 selects queries to be scaled out, generates rewritten queries, and sends the rewritten queries to the server computers 1 involved in the scale-out. The stream sending and receiving computer 2 keeps sending stream data and the server computers 1 fill the windows for the rewritten queries with tuples to synchronize the execution environment between the server computers 1 involved in the scale-out. Thereafter, the server computers 1 switch the queries to be executed to complete the dynamic scale-out.

### Embodiment 3

The foregoing Embodiment 2 has provided an example where the operation management computer 3 selects the queries to be scaled out. Embodiment 3 provides an example where the server computer 1 selects the queries to be scaled out. The remaining configuration is the same as that in Embodiment 2.

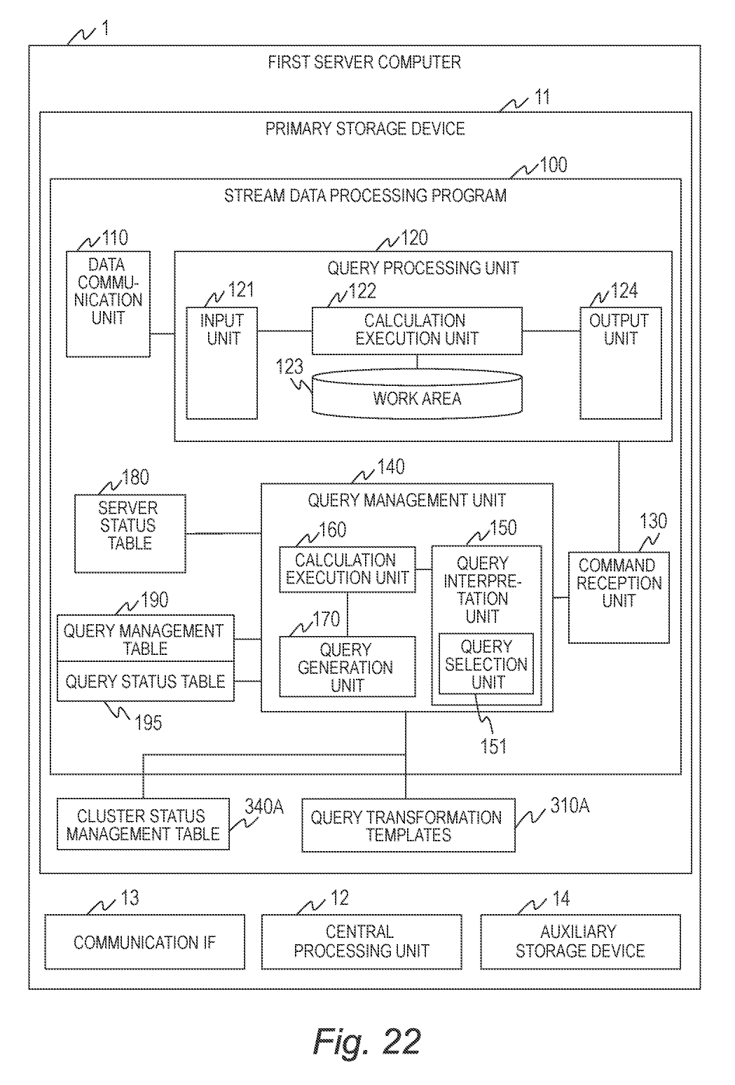

FIG. 22 is a block diagram for illustrating an example of a server computer, representing the third embodiment of this invention. Although the example in FIG. 22 is of the first server computer 1-1, the second server computer 1-2 has the same configuration; accordingly, duplicate explanations are omitted. The server computer 1 in Embodiment 3 is different from the server computer 1 in Embodiment 2 in the points where query transformation templates 310A and a cluster status management table 340A are additionally included in the primary storage device 11. The remaining configuration is the same as that in Embodiment 2. The query transformation templates 310A are copies of the query transformation templates 310 held by the operation management computer 3. The cluster status management table 340A has the same configuration as the cluster status management table 340 held by the operation management computer 3.

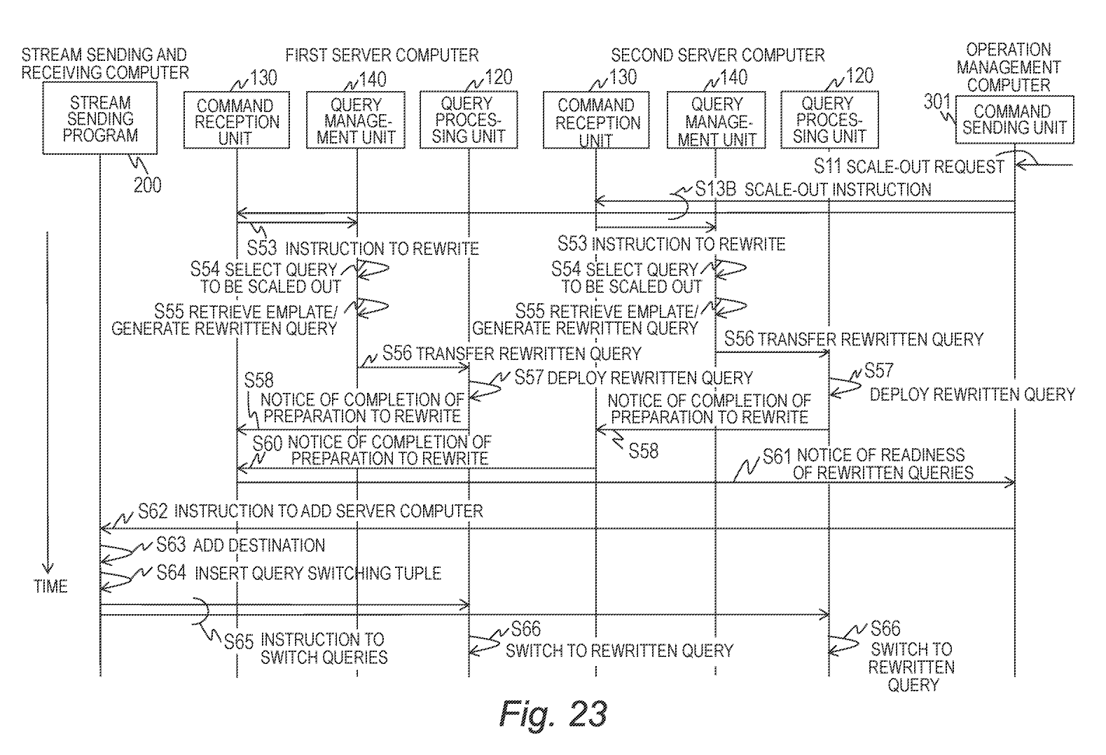

FIG. 23 is a sequence diagram for illustrating an example of scale-out processing to be performed in a computer system.

Step S11 is the same as Step S11 in FIG. 5 provided in Embodiment 1; the operation management computer 3 receives a scale-out request. Next, at Step S13B, the operation management computer 3 sends scale-out instructions to the first server computer 1-1 and the second server computer 1-2 to be involved in the scale-out. The second server computer 1-2 is a server computer configured as a standby computer in advance.

Upon receipt of the scale-out instruction from the operation management computer 3, the command reception unit 130 of the first server computer 1-1 sends an instruction to rewrite a query to the query management unit 140 (S53).

The query management unit 140 that has received the instruction to rewrite a query selects a query to be scaled out (S54). Selecting a query to be scaled out is the same as the processing of Steps S101 to S104 in FIG. 20 in the above-described Embodiment 2 and performed by the query management unit 140. Specifically, the query management unit 140 creates a cluster status management table 340A and calculates the individual costs to scale out the queries being executed based on the cluster status management table 340A (S103). The query management unit 140 selects queries in ascending order of the cost, determines whether the condition on the target value of the resource usage is satisfied, and determines the queries that satisfy the condition on the target value of the resource usage to be the queries to be scaled out (S104).

Next, the query management unit 140 generates rewritten queries by changing when to execute for each of the selected queries with reference to the query transformation templates 310A (S56). The query management unit 140 sends the generated rewritten queries to the query processing unit 120 (S56). The query processing unit 120 deploys the received rewritten queries to prepare for new stream data processing (S57).

Upon completion of deployment of the rewritten queries, the query processing unit 120 sends a notice of completion of preparation to rewrite queries to the command reception unit 130 (S58).

The standby second server computer 1-2 also performs the foregoing processing of Steps S53 to S58 to deploy the rewritten queries. Since the applicable node 3104 in the query transformation template 310A for the second server computer 1-2 is different from the one for the first server computer 1-1 as shown in FIG. 9, generated rewritten queries are different from the rewritten queries for the first server computer 1-1 in when to execute.

Upon completion of preparation of the rewritten queries, the command reception unit 130 of the second server computer 1-2 sends a notice of completion of preparation to rewrite queries to the first server computer 1-1 (S60). The command reception unit 130 of the first server computer 1-1 notifies the operation management computer 3 of the readiness of the rewritten queries in the server computers 1 involved in the scale-out (S61).

The operation management computer 3 sends an instruction to add the address of the new computer added for the scale-out to the stream sending and receiving computer 2 (S62). Like in FIG. 5 of Embodiment 1, the stream sending and receiving computer 2 adds the received address to the data destination management table 202 to add a new destination of stream data (S63).

Next, the stream sending and receiving computer 2 inserts a query switching tuple to the stream data to instruct the server computers 1 involved in the scale-out when to start using the rewritten queries (S64).

Next, the stream sending and receiving computer 2 sends switching instructions to the first server computer 1-1 and the second server computer 1-2 involved in the scale-out (S65).

The first server computer 1-1 and the second server computer 1-2 switches the queries to be executed to the deployed rewritten queries to start stream data processing (S66). Specifically, the first server computer 1-1 starts processing with the rewritten queries from the tuple next to the query switching tuple. The second server computer 1-2 stands by with the invoked rewritten queries until receiving the query switching tuple, and performs stream data processing with the rewritten queries on the tuples following the query switching tuple.

As understood from the above, dynamic scale-out can be performed in Embodiment 3, where the queries to be scaled out are selected by the server computer 1.

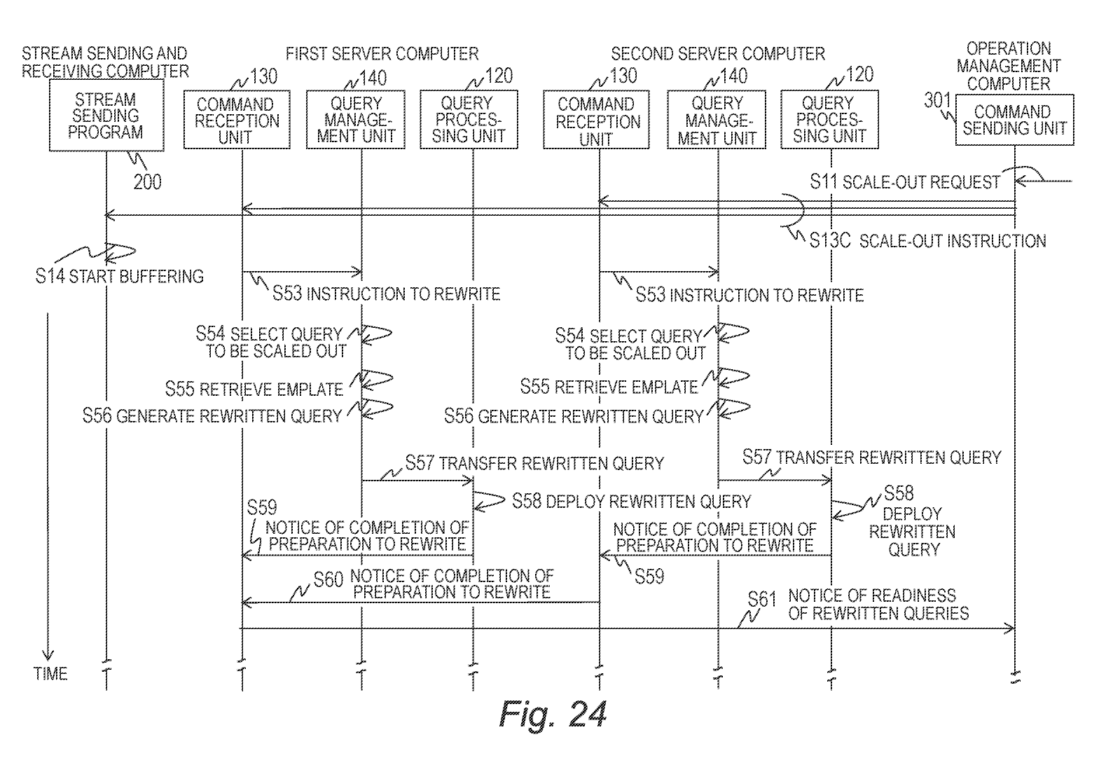

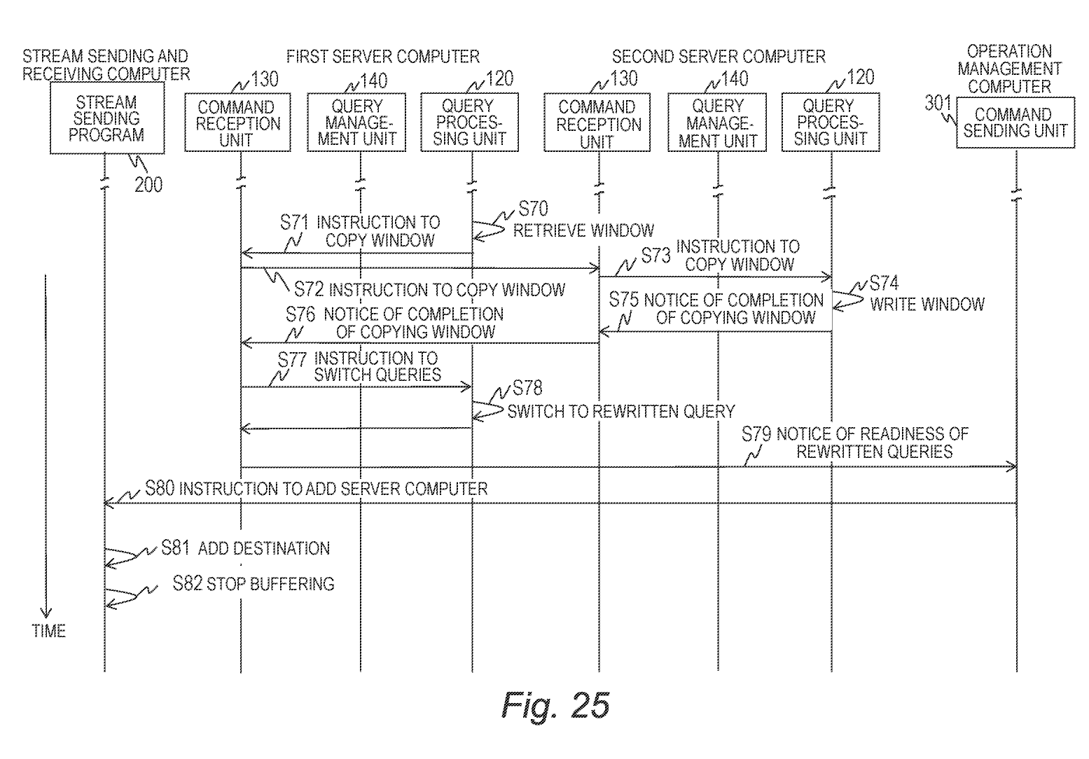

FIGS. 24 and 25 are sequence diagrams for illustrating an example of scale-out processing to be performed in a computer system, representing a modified example of the third embodiment. FIG. 24 is the former half of the sequence diagram for illustrating the scale-out processing performed in the computer system and FIG. 25 is the latter half of the sequence diagram for illustrating the scale-out processing performed in the computer system.

FIGS. 24 and 25 represent processing changed from the above-described processing in the cold standby method in FIG. 23 to the warm standby method in FIG. 5 of Embodiment 1.

Step S11 is the same as Step S11 in FIG. 5 provided in Embodiment 1; the operation management computer 3 receives a scale-out request. Next, at Step S13C, the operation management computer 3 sends scale-out instructions to the first server computer 1-1 and the second server computer 1-2 to be involved in the scale-out. The second server computer 1-2 is a server computer configured as a standby computer in advance.

At Step S14, the stream sending and receiving computer 2 that has received the scale-out instruction starts buffering the stream data that has been sent to the first server computer 1-1 and suspends sending the stream data to the first server computer 1-1.

Steps S53 to S61 are the same as those in the above-described FIG. 23: the query management units 140 of first server computer 1-1 and the second server computer 1-2 select queries to be scaled out, generate rewritten queries, and deploy the rewritten queries.

After completion of deployment of the rewritten queries, the query processing unit 120 of the first server computer 1-1 retrieves the current status of the windows for the queries (S70). The query processing unit 120 notifies the command reception unit 130 of the retrieved information on the windows. The command reception unit 130 sends an instruction to copy the windows to the command reception unit 130 of the second server computer 1-2 (S71).

Steps S70 to S76 are the same as Steps S22 to S28 in FIG. 5 of Embodiment 1: the command reception unit 130 of the second server computer 1-2 sends the data in the windows received from the first server computer 1-1 to the query processing unit 120 to synchronize the data in the windows for the rewritten queries by replacing the windows for the queries with the copies of the windows of the first server computer 1-1.

Through the foregoing processing, the same queries (rewritten queries) that are different only in when to execute are set to the first server computer 1-1 and the second server computer 1-2 and the windows for the rewritten queries are synchronized between the first server computer 1-1 and the second server computer 1-2. The command reception unit 130 of the first server computer 1-1 outputs an instruction to switch from the queries being executed to the deployed rewritten queries to the query processing unit 120 (S77). The query processing unit 120 stops executing the queries and switches to the deployed rewritten queries (S78).

Next, the command reception unit 130 of the first server computer 1-1 notifies the operation management computer 3 of completion of preparation to execute the rewritten queries (S79). The operation management computer 3 sends an instruction to add the address of the new computer added in the scale-out to the stream sending and receiving computer 2 (S80).

The stream sending and receiving computer 2 adds a destination of the stream data by adding the received address to the data destination management table 202 (S81). The stream sending and receiving computer 2 further stops buffering stream data and starts sending stream data to the second server computer 1-2 as well as the first server computer 1-1.

Through the above-described processing, dynamic scaling out by the warm standby method is completed, in which the queries to be scaled out are selected at a server computer 1.

### Conclusion

This invention is not limited to the embodiments described above, and encompasses various modification examples. For instance, the embodiments are described in detail for easier understanding of this invention, and this invention is not limited to modes that have all of the described components. Some components of one embodiment can be replaced with components of another embodiment, and components of one embodiment may be added to components of another embodiment. In each embodiment, other components may be added to, deleted from, or replace some components of the embodiment, and the addition, deletion, and the replacement may be applied alone or in combination.

Some of all of the components, functions, processing units, and processing means described above may be implemented by hardware by, for example, designing the components, the functions, and the like as an integrated circuit. The components, functions, and the like described above may also be implemented by software by a processor interpreting and executing programs that implement their respective functions. Programs, tables, files, and other types of information for implementing the functions can be put in a memory, in a storage apparatus such as a hard disk, or a solid-state drive (SSD), or on a recording medium such as an IC card, an SD card, or a DVD.

The control lines and information lines described are lines that are deemed necessary for the description of this invention, and not all of control lines and information lines of a product are mentioned. In actuality, it can be considered that almost all components are coupled to one another.

### Appendix

A computer scale-out method by adding a second computer to a first computer receiving stream data from a data source and executing a query to make the second computer execute the query together, the computer scale-out method comprising:

a first step of receiving, by a management computer connected with the first computer and the second computer, a request to scale out;

a second step of instructing, by the management computer, the first computer and the second computer to scale out;

a third step of generating, by the first computer and the second computer, rewritten queries that are copies of the query in which when to execute the query is rewritten;

a fourth step of switching, by the first computer and the second computer, to the rewritten queries;

a fifth step of notifying, by the first computer or the second computer, the management computer of readiness of the rewritten queries; and

a sixth step of sending, by the management computer, an instruction to add the second computer as a destination of the stream data to the data source to make the data source send the same stream data to the first computer and the second computer.

What is claimed is:

1. A computer scale-out method by adding a second computer to a first computer receiving stream data from a data source and executing a query to make the second computer execute the query, the computer scale-out method comprising:
a first step of receiving, by a management computer connected with the first computer and the second computer, a request to scale out;
a second step of generating, by the management computer, rewritten queries that are copies of the query in which when to execute the query is rewritten;
a third step of sending, by the management computer, instructions to scale out including the rewritten queries to the first computer and the second computer;
a fourth step of receiving, by the first computer and the second computer, the instructions to scale out, extracting the rewritten queries, and switching to the extracted rewritten queries;
a fifth step of notifying, by the first computer or the second computer, the management computer of readiness of the rewritten queries; and
a sixth step of sending, by the management computer, an instruction to add the second computer as a destination of the stream data to the data source to make the data source send the same stream data to the first computer and the second computer.

2. The computer scale-out method according to claim 1, wherein the fourth step further includes:
a step of switching, by the first computer, the query being executed to one of the rewritten queries; and
a step of starting, by the second computer, executing another rewritten query.

3. The computer scale-out method according to claim 2, wherein, in the second step, the rewritten queries include a first rewritten query to change the query executed by the first computer to be executed in a first execution timing mode and a second rewritten query to be executed by the second computer in a second execution timing mode.

4. The computer scale-out method according to claim 3, wherein the first execution timing mode and the second execution timing mode are configured to alternately provide outputs from the first rewritten query and outputs from the second rewritten query.

5. The computer scale-out method according to claim 4, wherein, in a case where a window size of the query is specified with time, the first timing mode and the second timing mode are configured so that time intervals to provide outputs from the first rewritten query alternate with time intervals to provide outputs from the second rewritten query.

6. The computer scale-out method according to claim 4, wherein, in a case where a window size of the query is specified with number of tuples of stream data, the first timing mode and the second timing mode are configured so that tuples output from the first rewritten query alternate with tuples output from the second rewritten query.

7. The computer scale-out method according to claim 1,
wherein the first step further includes a step of selecting, by the management computer, a query to be scaled out, and
wherein the second step further includes a step of generating, by the management computer, rewritten queries of the selected query.

8. The computer scale-out method according to claim 1, wherein the fourth step further includes a step of synchronizing execution environments for the rewritten queries between the first computer and the second computer.

9. The computer scale-out method according to claim 8,
wherein the third step further includes a step of making the data source stop sending stream data, and
wherein the sixth step further includes a step of making the data source resume sending stream data.

10. The computer scale-out method according to claim 8, wherein the sixth step further includes a step of inserting a tuple for triggering switching processing to use the rewritten queries into the stream data.

11. A computer system comprising:
a first computer configured to receive stream data from a data source and execute a query; and
a management computer configured to add a second computer for executing the query of the first computer,
wherein the management computer is configured to, upon receipt of a request to scale out, generate rewritten queries in which when to execute the query is rewritten as copies of the query and send instructions to scale out including the rewritten queries to the first computer and the second computer,
wherein the first computer and the second computer are configured to, upon receipt of the instructions to scale out, extract the rewritten queries, switch to the extracted rewritten queries, and notify the management computer of readiness of the rewritten queries, and
wherein the management computer is configured to send an instruction to add the second computer as a destination of the stream data to the data source to make the data source send the same stream data to the first computer and the second computer.

12. The computer system according to claim 11, wherein the first computer is configured to switch the query being executed to one of the rewritten queries and the second computer is configured to start executing another rewritten query.

13. The computer system according to claim 12, wherein the rewritten queries include a first rewritten query to change the query executed by the first computer to be executed in a first execution timing mode and a second rewritten query to be executed by the second computer in a second execution timing mode.

14. The computer system according to claim 13, wherein the first execution timing mode and the second execution timing mode are configured to alternately provide outputs from the first rewritten query and outputs from the second rewritten query.

15. A computer-readable non-transitory storage medium storing a program configured to be run on a computer including a processor and a memory, the program being configured to add a second computer to a first computer receiving stream data from a data source and executing a query to make the second computer execute the query by making the computer execute:
a first step of receiving a request to scale out;
a second step of generating rewritten queries that are copies of the query in which when to execute the query is rewritten;
a third step of sending instructions to scale out including the rewritten queries to the first computer and the second computer to make the first computer and the second computer switch to the rewritten queries;
a fourth step of receiving a notice of readiness of the rewritten queries from the first computer or the second computer; and
a fifth step of sending an instruction to add the second computer as a destination of the stream data to the data source to make the data source send the same stream data to the first computer and the second computer.
